(19) United States
(12) Patent Application Publication
(10) Pub. No.: US 2018/0014192 A1
(43) Pub. Date: Jan. 11, 2018

(54) Machine-To-Machine Gateway Architecture

(71) Applicant: InterDigital Patent Holdings, Inc., Wilmington, DE (US)

(72) Inventors: Sudhir B. Pattar, Mount Laurel, NJ (US); Inhyok Cha, Gangnam-Gu (KR); Andreas Schmidt, Kronberg (DE); Andreas Leicher, Frankfurt (DE); Yogendra C. Shah, Exton, PA (US); Prabhakar R. Chitrapu, Blue Bell, PA (US); Lawrence Case, Austin, TX (US)

(73) Assignee: InterDigital Patent Holdings, Inc., Wilmington, DE (US)

(21) Appl. No.: 15/699,843

(22) Filed: Sep. 8, 2017

Related U.S. Application Data
(63) Continuation of application No. 12/979,874, filed on Dec. 28, 2010.
Application No. 12/979,874 is a continuation of application No. 61/311,089, filed on Mar. 5, 2010.
(60) Provisional application No. 61/290,482, filed on Dec. 28, 2009.
(60) Provisional application No. 61/293,599, filed on Jan. 8, 2010.

(51) Int. Cl. H04W 12/06; H04W 4/00; H04W 12/10; H04W 12/08

(52) U.S. Cl. CPC H04W 12/06; H04W 4/005; H04W 4/00; H04W 12/10; H04W 12/08

(57) ABSTRACT

Systems, methods, and instrumentalities are disclosed that provide for a gateway outside of a network domain to provide services to a plurality of devices. For example, the gateway may act as a management entity or as a proxy for the network domain. As a management entity, the gateway may perform a security function relating to each of the plurality of devices. The gateway may perform the security function without the network domain participating or having knowledge of the particular devices. As a proxy for the network, the gateway may receive a command from the network domain to perform a security function relating to each of a plurality of devices. The network may know the identity of each of the plurality of devices. The gateway may perform the security function for each of the plurality of devices and aggregate related information before sending the information to the network domain.

### CROSS-REFERENCE TO RELATED APPLICATIONS

This application is based on, and claims priority to, U.S. Provisional Patent Application No. 61/290,482, filed on Dec. 28, 2009, U.S. Provisional Patent Application No. 61/293,599, filed on Jan. 8, 2010, and U.S. Provisional Patent Application No. 61/311,089, filed on Mar. 5, 2010, the contents of which are hereby incorporated by reference in their entirety.

### BACKGROUND

Machine-to-machine (M2M) architectures may use an M2M gateway that may be described as equipment using M2M capabilities to ensure M2M device interworking and interconnection to the network and application domain. The M2M gateway may also run M2M applications and may be co-located with M2M devices. Present M2M gateway architectures may have shortcomings.

### SUMMARY

Systems, methods, and instrumentalities are disclosed that provide for a gateway outside of a network domain to provide services to a plurality of devices. The gateway may provide service capabilities to the devices for the network domain, which may reduce the functionality that may otherwise need to be provided by the network domain.

The gateway may act as a management entity. The gateway may establish trust with the network domain. For example, the gateway may create a level of trust with the network domain in order for the gateway to interact with the network domain. The gateway may establish a connection with each of a plurality of devices. The gateway may perform a security function relating to each device. The gateway may perform the security function, which may be on behalf of the network domain. The gateway may perform the security function without the network domain directly participating or with minimal participation. The gateway may perform the security function without the network having knowledge of the particular devices. The gateway may report device information to the network domain relating to each device.

The gateway may act as a proxy on behalf of the network. The gateway may establish trust with the network domain. For example, the gateway may create a level of trust with the network domain in order for the gateway to interact with the network domain. The gateway may receive a command from the network domain to perform a security function relating to each of a plurality of devices. For example, the gateway may receive a single command from the network domain, and in response, perform a security function for multiple devices. The network may know the identity of each of the plurality of devices. The gateway may perform the security function for each of the plurality of devices. The gateway may aggregate information from each of the plurality of devices relating to the performed security function, and, send the aggregated information to the network domain. The gateway may process the aggregated information, and, send the processed aggregated information to the network domain.

The security function performed by the gateway may comprise one or more of the following: registering and authenticating devices with the network domain with or without using boostrapped credentials; provisioning and migration of credentials to each of the plurality of devices; provisioning of security policies to each of the plurality of devices; performing authentication of each of the plurality of devices; establishing a trustworthy functionality in each of the plurality of devices, wherein an integrity validation for each of the plurality of devices is performed; providing device management, which may include fault finding and fault remediation, for each of the plurality of devices; or, establishing, for at least one of the plurality of devices, at least one of: a security association, a communication channel, or a communication link.

### BRIEF DESCRIPTION OF THE DRAWINGS

A more detailed understanding may be had from the following description, given by way of example in conjunction with the accompanying drawings wherein:

FIG. 1 illustrates an exemplary wireless communication system;

FIG. 2 illustrates an exemplary WTRU and Node-B;

FIG. 3 illustrates an exemplary M2M architecture;

FIG. 4 illustrates an exemplary case 3 gateway functionality;

FIG. 5 illustrates an exemplary bootstrapping and registration flow for case 3 connected devices;

FIG. 6 illustrates an exemplary bootstrapping and registration flow for case 4 connected devices;

FIG. 7 illustrates an exemplary hierarchical connectivity architecture;

FIG. 8 illustrates an exemplary call flow diagram for case 3 and 4 device integrity validations;

FIG. 9 illustrates an exemplary call flow diagram for case 1 device integrity and registration;

FIG. 10 illustrates an exemplary call flow diagram for case 2 device and gateway integrity and registration;

FIG. 11 illustrates an exemplary call flow diagram for case 3 device and gateway integrity and registration;

FIG. 12 illustrates an exemplary call flow diagram for case 4 device and gateway integrity and registration; and

FIG. 13 illustrates an exemplary scenario for layered validation;

FIG. 14 illustrates an exemplary M2M architecture;

FIG. 15 illustrates an exemplary architecture of service capabilities of the M2M network layer; and

FIGS. 16A and 16B illustrate an exemplary architecture of the M2M gateway and interfaces;

FIG. 17A is a system diagram of an example communications system in which one or more disclosed embodiments may be implemented;

FIG. 17B is a system diagram of an example wireless transmit/receive unit (WTRU) that may be used within the communications system illustrated in FIG. 17A;

FIG. 17C is a system diagram of an example radio access network and an example core network that may be used within the communications system illustrated in FIG. 17A;

### DETAILED DESCRIPTION OF ILLUSTRATIVE EMBODIMENTS

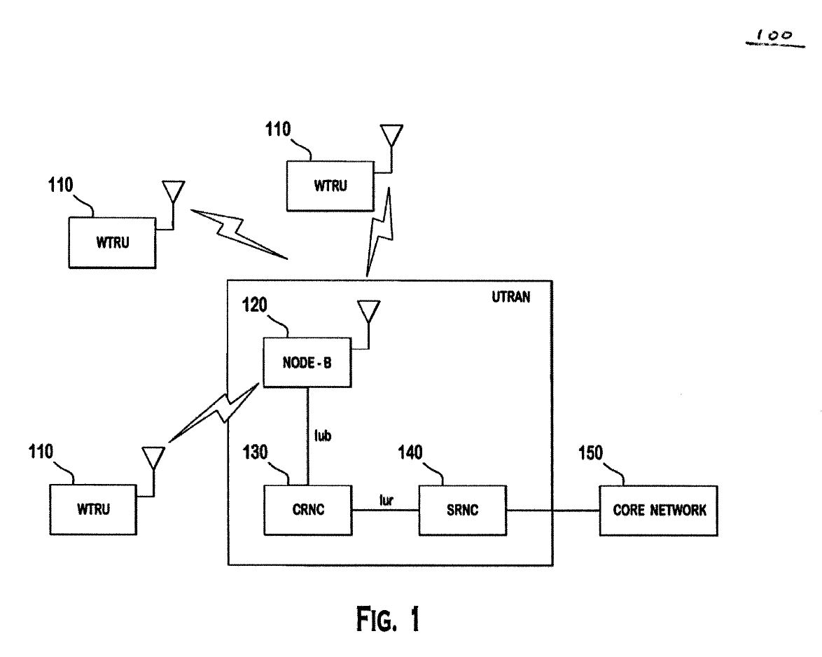

FIGS. 1-17 may relate to exemplary embodiments in which the disclosed systems, methods and instrumentalities may be implemented. However, while the present invention may be described in connection with exemplary embodiments, it is not limited thereto and it is to be understood that other embodiments may be used or modifications and additions may be made to the described embodiments for performing the same function of the present invention without deviating therefrom. For example, the disclosed systems, methods, and instrumentalities may be illustrated with reference to M2M implementations, however, implementation are not limited thereto. In addition, the disclosed systems, methods, and instrumentalities may be illustrated with reference to wireless implementations, however, implementation are not limited thereto. For example, the disclosed systems, methods, and instrumentalities may be applicable to wireline connections. Further, the figures may illustrate call flows, which are meant to be exemplary. It is to be understood that other embodiments may be used. Further, the order of the flows may be varied where appropriate. In addition, flows may be omitted if not needed and additional flows may be added.

When referred to hereafter, the terminology “wireless transmit/receive unit (WTRU)” may include, but is not limited to, a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” may include, but is not limited to, a Node-B, a site controller, an access point (AP), or any other type of interfacing device capable of operating in a wireless environment.

FIG. 1 shows an exemplary wireless communication system 100, including a plurality of WTRUs 110, a base station such as a Node-B 120, a controlling radio network controller (CRNC) 130, a serving radio network controller (SRNC) 140, and a core network 150. The Node-B 120 and the CRNC 130 may collectively be referred to as the UTRAN.

As shown in FIG. 1, the WTRUs 110 may be in communication with the Node-B 120, which is in communication with the CRNC 130 and the SRNC 140. Although three WTRUs 110, one Node-B 120, one CRNC 130, and one SRNC 140 are shown in FIG. 1, it should be noted that any combination of wireless and wired devices may be included in the wireless communication system 100.

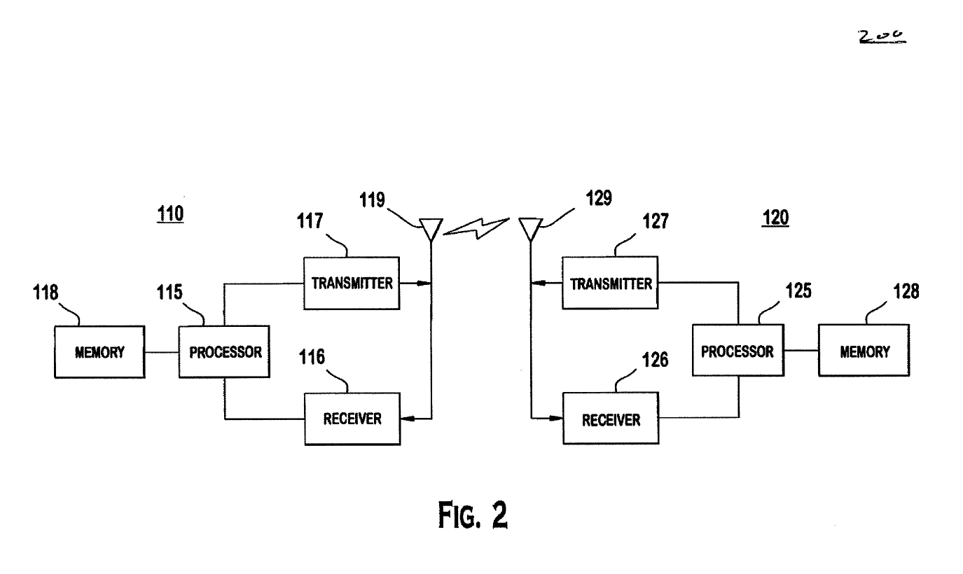

FIG. 2 is a functional block diagram 200 of an exemplary WTRU 110 and Node-B 120 of the wireless communication system 100 of FIG. 1. As shown in FIG. 2, the WTRU 110 may be in communication with the Node-B 120 and both may be configured to assist a machine to machine (M2M) gateway that uses M2M capabilities to ensure M2M devices interworking and interconnection to the network and application domain.

In addition to the components that may be found in a typical WTRU, the WTRU 110 may include a processor 115, a receiver 116, a transmitter 117, a memory 118 and an antenna 119. The memory 118 may store software, including an operating system, applications and other functional modules. The processor 115 may perform, alone or in association with the software, a method to assist a machine to machine (M2M) gateway that uses M2M capabilities to ensure M2M devices interworking and interconnection to the network and application domain. The receiver 116 and the transmitter 117 may be in communication with the processor 115. The antenna 119 may be in communication with both the receiver 116 and the transmitter 117 to facilitate the transmission and reception of wireless data.

In addition to the components that may be found in a typical base station, the Node-B 120 may includes a processor 125, a receiver 126, a transmitter 127, and an antenna 128. The processor 125 may be configured to work with a machine to machine (M2M) gateway that uses M2M capabilities to ensure M2M devices interworking and interconnection to the network and application domain. The receiver 126 and the transmitter 127 may be in communication with the processor 125. The antenna 128 may be in communication with both the receiver 126 and the transmitter 127 to facilitate the transmission and reception of wireless data.

Systems, methods, and instrumentalities are disclosed that provide for a gateway outside of a network domain to provide services to a plurality of devices. The gateway may provide service capabilities to the devices for the network domain, which may reduce the functionality that may otherwise need to be provided by the network domain.

The gateway may act as a management entity. The gateway may establish trust with the network domain. For example, the gateway may create a level of trust with the network domain in order for the gateway to interact with the network domain. The gateway may establish a connection with each of a plurality of devices. The gateway may perform a security function relating to each device. The gateway may perform the security function, which may be on behalf of the network domain. The gateway may perform the security function without the network domain directly participating or with minimal participation. The gateway may perform the security function without the network having knowledge of the particular devices. The gateway may report device information to the network domain relating to each device.

The gateway may act as a proxy on behalf of the network. The gateway may establish trust with the network domain. For example, the gateway may create a level of trust with the network domain in order for the gateway to interact with the network domain. The gateway may receive a command from the network domain to perform a security function relating to each of a plurality of devices. For example, the gateway may receive a single command from the network domain, and in response, perform a security function for multiple devices. The network may know the identity of each of the plurality of devices. The gateway may perform the security function for each of the plurality of devices. The gateway may aggregate information from each of the plurality of devices relating to the performed security function, and, send the aggregated information to the network domain. The gateway may process the aggregated information, and, send the processed aggregated information to the network domain.

The security function performed by the gateway may comprise one or more of the following: registering and authenticating devices with the network domain with or without using boostrapped credentials; provisioning and migration of credentials to each of the plurality of devices; provisioning of security policies to each of the plurality of devices; performing authentication of each of the plurality of devices; establishing a trustworthy functionality in each of the plurality of devices, wherein an integrity validation for each of the plurality of devices is performed; providing device management, which may include fault finding and fault remediation, for each of the plurality of devices; or, establishing, for at least one of the plurality of devices, at least one of: a security association, a communication channel, or a communication link.

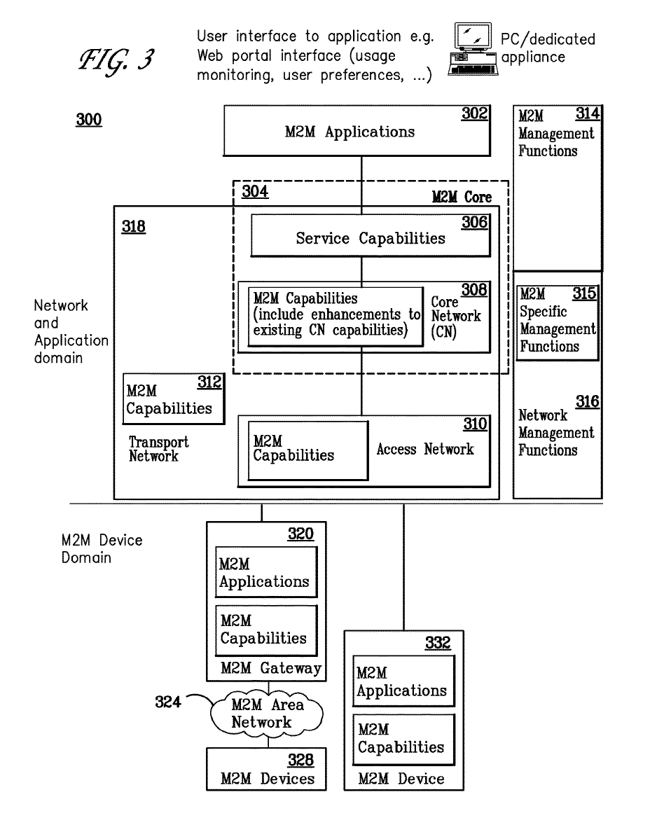

FIG. 3 illustrates an embodiment of M2M architecture that may be used with the disclosed systems, methods, and instrumentalities. The M2M gateway 320 may be configured to perform as an aggregator for the M2M devices connected to it, such as M2M device 328, via the M2M area network 324. Each M2M device connected to the M2M gateway 320 may include a M2M device identification and authenticate with the M2M network.

In the M2M device domain 360, there is a M2M device 332 that runs application(s) using the M2M capabilities and network domain functions. An M2M device may be either connected straight to an access network 310 (e.g., M2M device 332) or interfaced to the M2M gateway 320 via the M2M area network 324 (e.g., M2M device 328). The M2M area network 324 may provide connectivity between M2M devices and M2M gateways. Some examples of M2M area networks include: personal area network technologies such as IEEE 802.15, Zigbee, Bluetooth and other similar technologies. The terms M2M area network and M2M capillary network may be used interchangeably. The M2M gateway 320 may be equipment that uses M2M capabilities to ensure M2M device interworking and interconnection to the network domain 350, which may also be referred to as network and applications domain 350. The M2M gateway 320 may also run M2M applications. M2M gateway functionality may be co-located with M2M device(s). As an example, an M2M gateway, such as M2M gateway 320, may implement local intelligence in order to activate automation processes resulting from the collection and treatment of various information sources (e.g. from sensors and contextual parameters).

In the network domain 350, there is a M2M access network 310 that may allow the M2M device domain 360 to communicate with the core network 308. M2M capabilities, based on existing access networks, may be required to provide enhancements to the delivery of M2M services. Examples of access networks include: digital subscriber line technologies (xDSL), hybrid fiber-coaxial (HFC), power line communications (PLC), satellite, Global System for Mobile (GSM) Enhanced Data rates for GSM Evolution (EDGE) Radio Access Network (GERAN), Universal Mobile Telecommunications System (UMTS) Terrestrial Radio Access Network (UTRAN), evolved UTRAN (eUTRAN), wireless local area network (W-LAN) and WiMAX.

There may also be transport networks, such as transport network 318, that may allow transport of data within the network domain 350. M2M capabilities, based on existing transport networks, may be required to provide enhancements to the delivery of M2M services. The M2M core 304 is composed of a core network 308 and service capabilities. The M2M core network 308 may provide IP connectivity, service and network control functions, interconnection (with other networks), roaming (for public land mobile network (PLMN)), etc. Different core networks may offer different capability sets. M2M capabilities, based on existing core networks, may be required to provide enhancements to the delivery of M2M services. Examples of core networks may include Third Generation Partnership Project (3GPP) core networks (e.g. General packet radio service (GPRS), evolved packet core (EPC)), ETSI Telecommunications and Internet converged Services and Protocols for Advanced Networking (TISPAN) core networks. In the case of an IP Service Provider network, the core network may provide limited functions.

Service capabilities 306 provide functions that may be shared by different applications. Service capabilities 306 expose functionalities through a set of open interfaces. Additionally, service capabilities 306 may use core network functionalities. Service capabilities 306 may be used to optimize applications development and deployment and to hide network specificities to applications. Service capabilities 306 may be M2M specific or generic, e.g., providing support to other than M2M applications. Examples include data storage and aggregation, unicast and multicast message delivery, etc.

M2M applications 302 may include applications that run the service logic and use service capabilities accessible via open interfaces. Network management functions 316 may comprise functions required to manage the access network 310, transport network 318 and core network 308, including related M2M capabilities, such as provisioning, supervision, fault management and other such functions. M2M specific management functions 315 may be included within the network management functions 316 to manage M2M capabilities in the access network 310, transport network 318 and core network 308. M2M management functions 314 may comprise functions required to manage the M2M applications 302 and service capabilities 306, as well as functionality of the M2M devices and gateways (e.g., M2M gateway 320, M2M device 328, M2M device 332, etc. The management of M2M devices and gateways may use service capabilities (e.g. device management service capability). The M2M management functions 314 may include functions for fault-finding and fault-remediation of M2M devices 328 or M2M gateways 320.

M2M architectures and multiple M2M device connectivity methods are presented herein. M2M devices may connect to M2M networks in a number of ways. Four exemplary cases are illustrated. In a first case (case 1), M2M devices connect to the M2M system directly via the access network. A M2M device is registered and authenticated to the M2M system. In a second case (case 2), a M2M device connects to the M2M system via an M2M gateway area network. The M2M gateway connects to the M2M system via an access network. The M2M device is authenticated to the M2M system via the M2M gateway. The area network may or may not be a cellular network, WLAN, BT and other systems. In case 2, the M2M gateway may merely act as a tunnel for a M2M device. Procedures such as registration, authentication, authorization, management and provisioning of the M2M device are performed by the M2M network.

Two additional cases are now presented. In case 3, the gateway, such as M2M gateway 320, may act as a management entity. The M2M device, such as M2M device 328, may connect to the M2M gateway 320, e.g., via an M2M area network 324. The M2M gateway 320 may connect to, and establish trust with, the M2M network domain 350, where the connection may be via the access network 310. The M2M gateway 320 may manage M2M devices that connect to it in a way that is independent of the control of the M2M network domain 350, by, for example, reusing existing methods of registration, authentication, authorization, managing, and provisioning, provided by the area network 310. The devices that connect to such a gateway may or may not be addressable by the M2M network domain 350. The M2M area network 324 may or may not be a cellular network, WLAN, BT or other such network. The gateway may perform a security function for each M2M device connected to it. The gateway may perform the security function without the M2M network domain 350 directly participating or having knowledge of the particular devices, or with minimal participation by the M2M network domain 350. The M2M gateway 320 may report information to the network domain relating to each device for the performed security function.

In case 4, the gateway, such as M2M gateway 320, may act as a proxy on behalf of the network., e.g., network domain 350. The M2M device, such as M2M device 328, connects to the M2M gateway 320, e.g., via an M2M area network 324. The devices that connect to such a gateway may or may not be addressable by the M2M network. The M2M gateway 320 may connect to, and establish trust with, the M2M network domain 350, where the connection may be via an access network 310. The M2M gateway 320 acts as a proxy for the M2M network domain 350 towards the M2M devices, such as M2M device 328, that are connected to it. Such a M2M gateway may receive a command from a network domain to perform a security function relating to each M2M device connected to it. For example, the gateway may receive a single command from the network domain, and in response, perform a security function for multiple devices. The gateway may perform the security function. The gateway may perform procedures such as authentication, authorization, registration, device management and provisioning, and may also execute applications, on behalf of the M2M network. The gateway may aggregate information from each of the plurality of devices relating to the performed security function, and, send the aggregated information to the M2M network domain 350. The gateway may process the aggregated information, and send the processed aggregated information to the network domain.

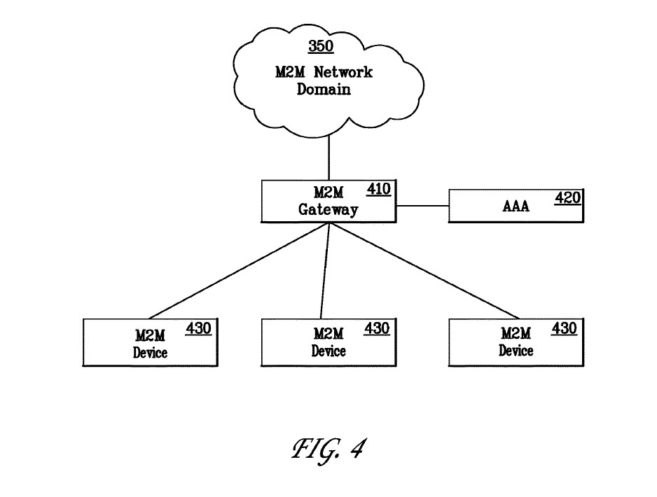

FIG. 4 shows an example of case 3 gateway functionality. The M2M gateway 410, which may be connected to M2M network domain 350, maintains a local AAA server 420 for the M2M devices 430 connected by the M2M area network (e.g., capillary network). The AAA server 420 facilitates the local registration, authentication, authorization, accounting, and device integrity validation.

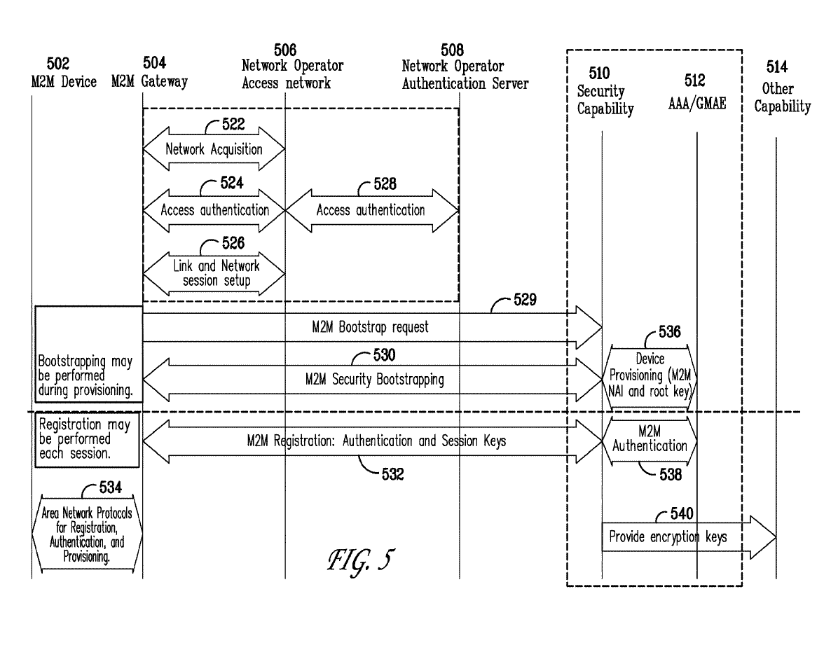

For case 3 connected devices, M2M area network protocols and procedures for registration, authentication, authorization, and device management are used. The devices may or may not be addressable by the M2M network domain 350. The gateway appears as an M2M device to the M2M network and performs registration and authentication. FIG. 5 illustrates an exemplary bootstrapping and registration flow for case 3 connected devices or connectivity scenarios.

FIG. 5 illustrates M2M device 502, M2M gateway 504, access network 506 (e.g., associated with the network operator), authentication server 508 (e.g., associated with the network operator), security capability 510, AAA/GMAE 512 and other capability 514. At 522, M2M gateway 504 acquires the network via access network 506. At 524 and 528 access authentication may be performed between M2M gateway 504 and access network 506, and, between access network 506 and authentication server 508. At 526, link and network session setup may be performed between M2M gateway 504 and access network 506. Bootstrapping includes the flows at 529 and 530. Bootstrapping may be limited to performance during provisioning. At 529, a bootstrap request may be performed between M2M gateway 504 and security capability 510. At 530, M2M security bootstrapping may be performed between M2M gateway 504 and security capability 510. At 536, device provisioning (e.g., provisioning of data such as an M2M network address identifier (NAI) and root key, or other service or application-level parameter or data) may be performed between security capability 510 and AAA/GMAE 512. At 532, M2M registration, including authentication and generation of session keys takes place between M2M gateway 504 and security capability 510. At 538, M2M authentication, which may authenticate the M2M device, a service capability, a set of service capabilities, or one or more applications of the M2M device, may take place between security capability 510 and AAA/GMAE 512. At 540, security capability 510 may provide encryption keys to other capability 514. At 534, area protocols, registration, authentication, and provisioning may take place between M2M device 502 and M2M gateway 504.

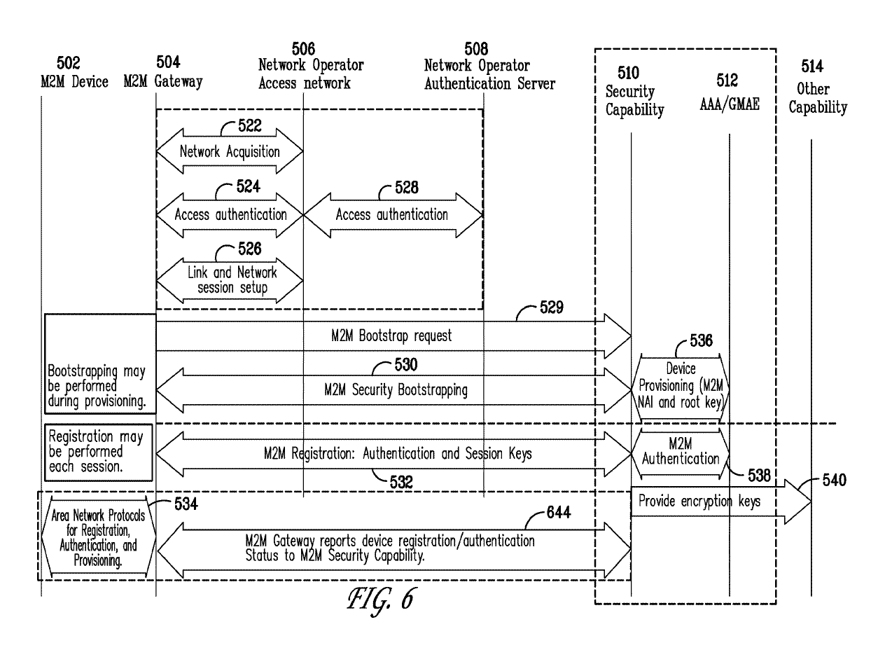

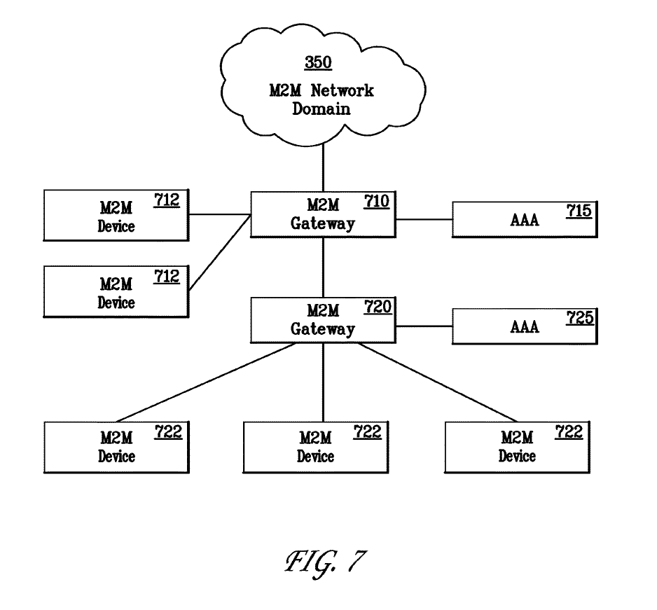

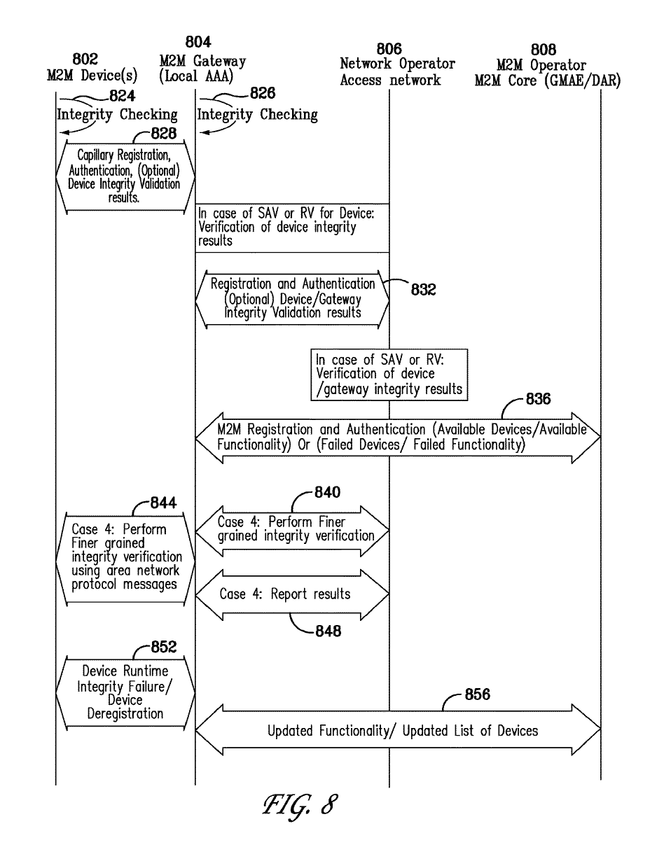

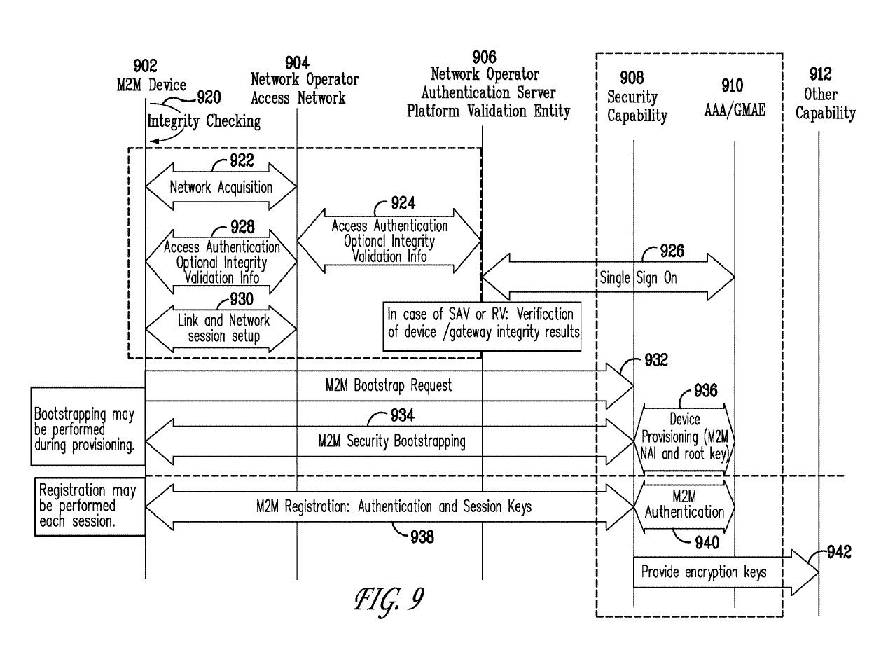

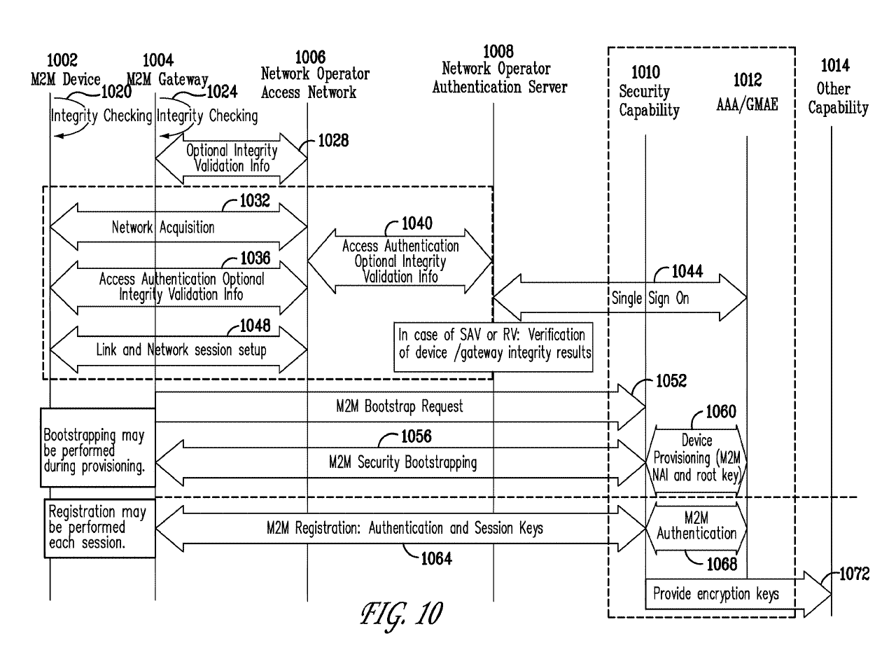

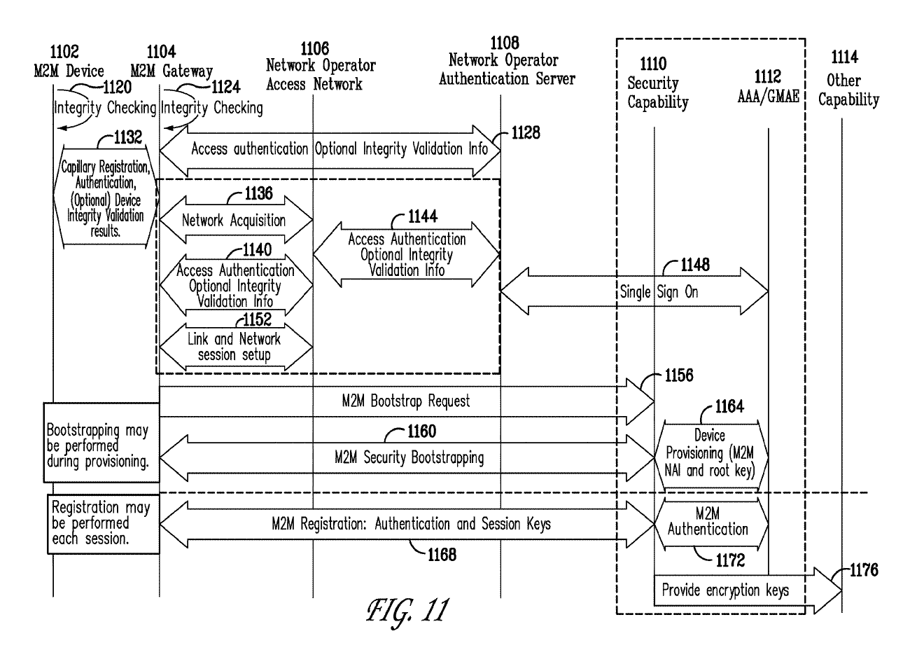

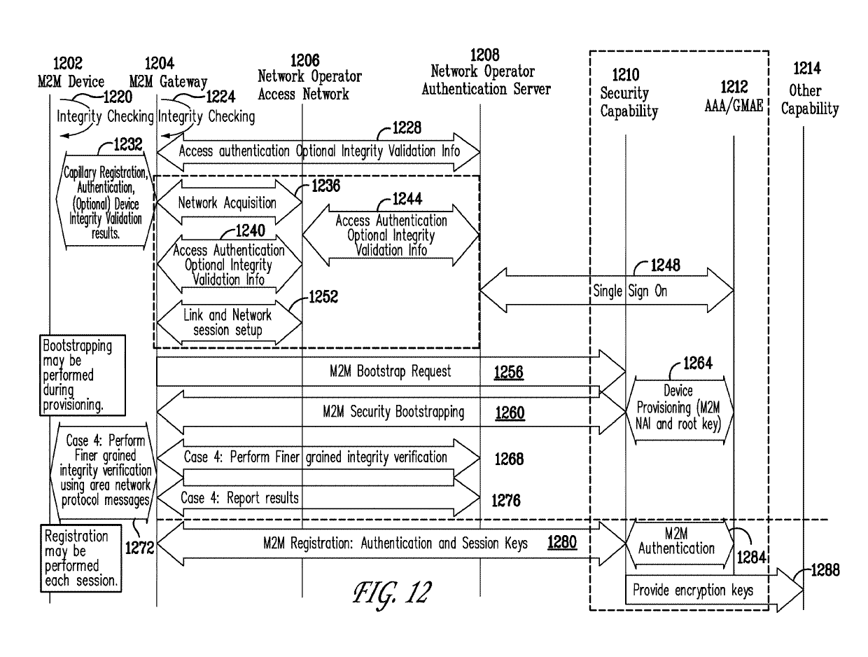

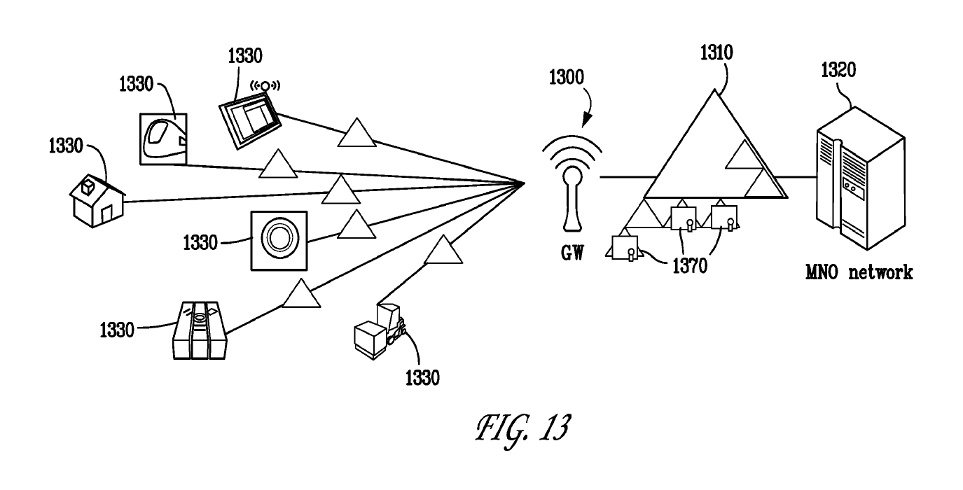

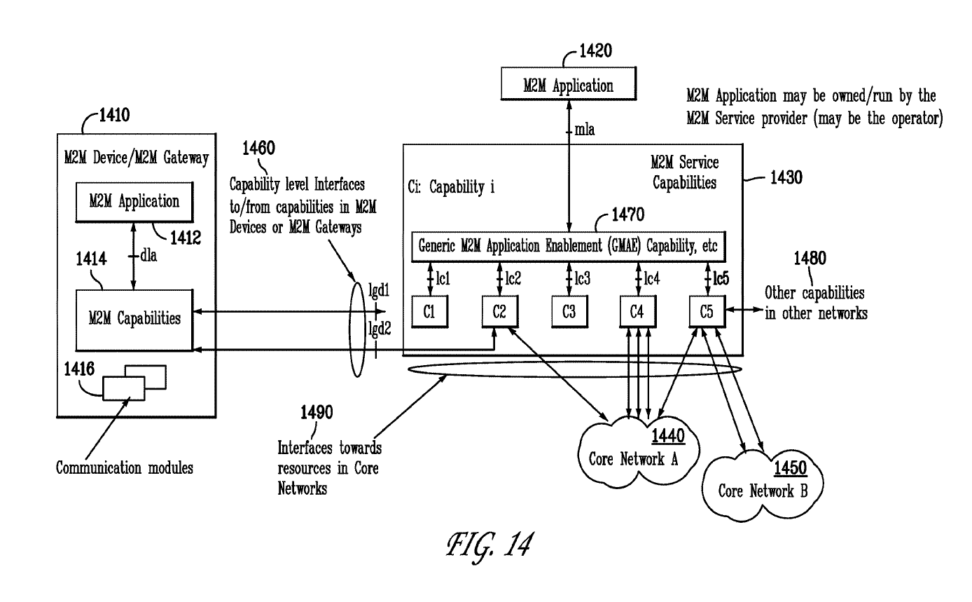

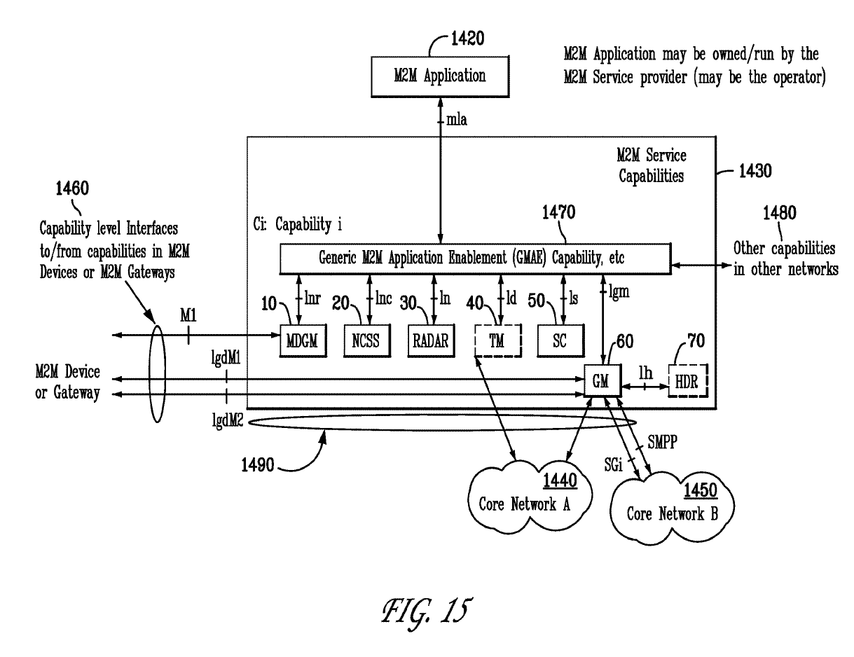

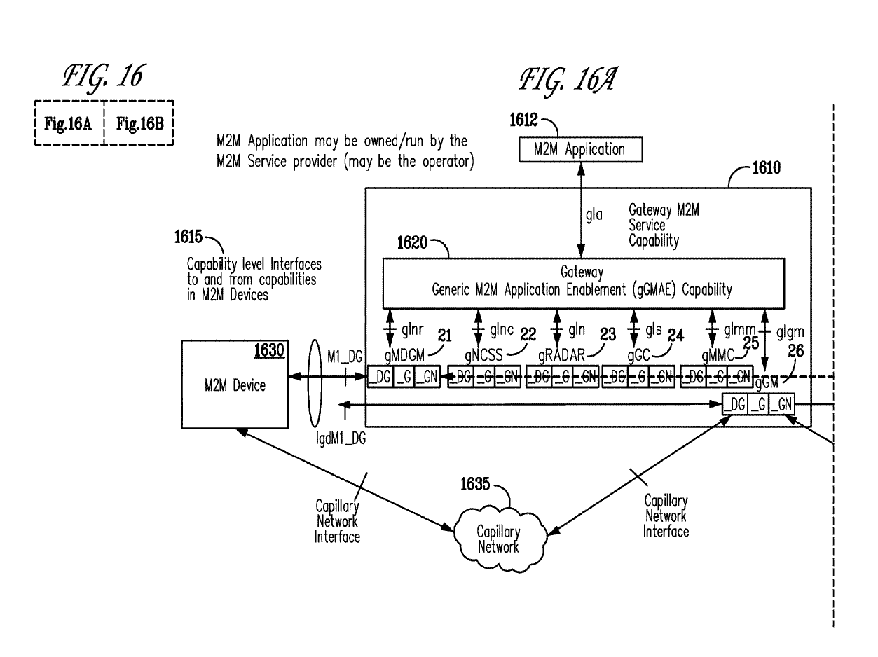

For case 4 connected devices, area network protocols and procedures for registration authentication, authorization and device management may be used. An interworking function may exist on the M2M gateway that translates M2M network commands to the M2M devices. The devices may or may not be addressable by the M2M network domain. FIG. 6 illustrates an exemplary bootstrapping and registration flow for case 4 connected devices. The case 4 flows illustrated in FIG. 6 comprise the flows of FIG. 5. In addition, at 644, device registration/authentication status reporting may take place between M2M gateway 504 and security capability 510 of the M2M network domain.

Still referring to the case 4 example, the M2M gateway registers and authenticates to the network to establish trust in the network so as to act as a proxy for the network. In such cases, the M2M gateway may: perform M2M device provisioning; perform M2M device local registration (including local-area authentication) and identity management; perform M2M authentication (e.g., of one or more M2M devices, one or more services of an M2M device, or one or more applications of the M2M device), authorization, and accounting; perform M2M device integrity validation; act as a proxy for the network such that it may: validate itself towards the network; validate the devices attached to the M2M access network; manage security and trust including authentication and identity management of M2M devices including managing and maintaining the security associations of the M2M devices; and perform local IP access routing.

Such a M2M gateway may be used in many applications. By way of example, and not limitation, it may be used in an evolved femto cell, evolved Home Node-B, or Home Node-B realizations with wired or wireless back haul. It may also be used as a digital proxy for network, and/or user. The network may be unaware of the M2M devices; the gateway may act on behalf of the network to manage and maintain the M2M device connections. The M2M gateway that acts as a digital proxy may have a handset or other mobile terminal form factor. It may also be used in eHealth scenarios, where the sensors and actuators are connected to the M2M gateway. The sensors/actuators may not register and authenticate to the M2M network domain. Instead, these M2M devices (sensors/actuators) may register to the M2M gateway. In these applications, the M2M gateway may be a handheld device, such as a PDA or mobile phone or a traffic aggregator such as an access point or router. The connectivity may be such that the M2M gateway may perform the proxy functionality for a subset of the connected M2M devices, and, for other M2M devices connected to it, it may perform as a case 2 M2M gateway. The connectivity may be such that, the M2M gateway acts and appears as a case 1 connected M2M device to the M2M access network and core network and the M2M devices connected to the M2M gateway may be independently managed by the M2M gateway. The connectivity may be such that the M2M Gateway acts as a M2M device to another M2M gateway as illustrated in FIG. 7, e.g., M2M gateway 720 may acts as a M2M device to M2M gateway 710. M2M gateway 710 may maintain a local AAA server 715 for the M2M devices 712 connected by an M2M area network (a.k.a capillary network). M2M gateway 720 may maintain a local AAA server 725 for the M2M devices 722 connected by an M2M area network (e.g., capillary network).

Integrity validation may include localized actions as well as reporting and remote actions based on measurements carried out locally, e.g., the validation may be implicit or explicit through signaling. In order to realize device integrity checks and validation, the M2M device may comprise a trusted execution environment. From the trusted execution environment, the device may check the integrity of its software and verify the integrity against trusted reference values prior to its loading and execution by a secure boot process. These trusted reference values may be issued by a trusted third party or the trusted manufacturer, and, are the measurement values (for example hash values) of the unit being verified. The verification of the integrity of the software may be performed locally (e.g., autonomous validation) or remotely (e.g., semiautonomous validation and fully remote validation). If device integrity validation is performed remotely, the entity that does the validation may be the M2M gateway or the designated entity or proxy of the M2M gateway acting as a validation entity. If the targets of validation are M2M devices that are connected to the M2M gateway, and/or a network-based validation entity on the M2M network or the designated entity or proxy of the M2M network, then the targets of validation may be either M2M devices or M2M gateways, or, some combination of both.

In fully remote validation, the target entity (whose integrity is to be validated) may send measurements, without evidence or outcome of locally performed verification, of its integrity toward the validation entity. On the other hand, in semiautonomous validation, the target entity may both make measurements of its integrity, and make some verification/assessment of the measurements, and, may send to the validation entity the evidence or information relating to the outcome of verification.

If the integrity checking process is performed locally, then the trusted reference values may be stored in a secure memory and access may be limited to authorized access. If the verification is performed at a remote validation entity (e.g., a M2M gateway acting as a validation entity, or a network-based validation entity on the M2M network), then the gateway or the network-based validation entity may fetch these trusted references values from a trusted third party or the trusted manufacturer either during the process of validation or pre-fetch it and store it locally. These trusted reference values may also be provisioned at the validating entity in the M2M gateway or M2M network by the operator or the user. Such trusted reference values may be issued by the trusted third party or the trusted manufacturer over the air, over the wire, or, in a secured media such as a secure Universal Serial Bus (USB), secure smart card, secure digital (SD) card, where the user or the operator may insert the secured media at the M2M gateway (e.g., for semi-autonomous validation) or at the M2M device (e.g., for autonomous validation). For M2M network based semi-autonomous validation, the validating entity may obtain such information directly from the trusted manufacturer or the trusted third party.

New updates to the M2M area network protocols may be necessary for sending the integrity results from the device to the verifying entity in the M2M gateway. This may be implemented by updating protocol fields or by sending a datagram comprising the integrity results and metrics in the initial random access messages or after setting up a connection in acknowledged or unacknowledged form.

Device integrity validation may be performed autonomously or semi-autonomously using one or more of the following exemplary methods.

Device validation procedures may be provided for case 1 devices.

In this case, the devices may be connected to the M2M network directly through a core network. In devices where autonomous validation is supported, the initial access by the device to the access network may comprise the results of the local integrity check and validation. By the fact that the device has attempted to register in the network, it may be assumed by the network that the device integrity validation has succeeded. If the device integrity check fails, then the list of failed entities or functionalities may be included in a distress signal and the network may take necessary steps for remediation or recovery of the device.

For semi-autonomous validation, a verifying entity may be needed in either the access network or the M2M network, or both. This verifying entity may be the platform validating entity and may be co-located with the authentication, authorization and accounting (AAA) server. The results of the local integrity check may be sent to the platform validity entity (PVE), which decides if the integrity check has passed or failed. For successful checks, the PVE may allow the device to register in the access network and/or the M2M service capability layer or the M2M network. For a failed check, the PVE may redirect the device to a remediation server for downloading updates or patches. For a failed check, the PVE may quarantine the device and signal the OAM to send personnel to fix the device.

Device validation procedures may be provided for case 2 devices and gateways.

In this case, the devices may be connected to the M2M network via a M2M gateway. The devices are addressable by the M2M network. The M2M gateway acts as a tunnel provider in such cases. It may be useful to consider the integrity checks of the gateway and the devices separately. First, the gateway may be verified for integrity either semi-autonomously or autonomously as described herein where the device is replaced by the gateway. Following the successful integrity check of the gateway, the devices may be allowed to connect to the M2M gateway. The integrity check of the devices may then performed. This may be performed either autonomously or semi-autonomously by the PVE in an access network, by the M2M service capability layer or the M2M network.

For semi-autonomous validation, the M2M gateway may perform the task of the security gateway where it may perform access control for the M2M devices. It may prevent access to a PVE until the device integrity check procedures are completed for the M2M devices, and, if the M2M device integrity check fails, then it may perform access control and restrict the access of the M2M device by either quarantining it or restricting access to remediation entities.

Device validation procedures may be provided for case 3 and case 4 devices and gateways.

The device may perform an autonomous validation, in which the device integrity may be checked and validated by either the gateway or the network implicitly. The device may perform a semi-autonomous or fully remote validation where the device sends integrity check results or information or summary of the results (e.g., a list of failed functionality corresponding to the integrity check failed components) to a verifying entity.

In case 3 connectivity, the verifying entity for the M2M devices may be the M2M gateway. The M2M network (and/or the access network) may need another entity (or entities, if the integrity validation needs to be done toward both—but separately—the M2M network and the access network) to act as a verification entity for the integrity of the M2M gateway. The M2M network and/or the access network may “validate” the integrity of the M2M devices in an indirect way, by verifying the integrity of the M2M gateway where the gateway, after verification of its integrity, may be “trusted” to perform its own role of verifying the integrity of the M2M devices.

In case 4 connectivity, the role of the verifying entity for the integrity of the M2M devices may be split between the M2M gateway and the M2M network. The role of the verifying entity for the integrity of the M2M gateway may need to be taken up by an entity on the M2M network or the access network. Whether and how (including the extent) the (verifying entity) roles are split between the M2M gateway and the M2M network (and/or access network) may be defined by one or more policies. If split validation using a tree-like structure (e.g., tree-formed verification) is used, the policy may dictate that the M2M gateway perform a coarse-grained integrity verification of the devices, and report the results to the verifying entity or entities in the M2M network (and/or access network). The verifying entity may look and assess these results, and depending on the outcome of the assessment and its own policy, it may perform, directly or indirectly through the gateway, finer-grained integrity verification.

One such policy may be from the M2M operator, and another such policy may be from the access network operator. Other stakeholders may also employ and use their own policies.

If the device integrity check passes, then the device may proceed with registration and authentication with the network. The registration and authentication of the device may be performed locally within the M2M area network for case 3 connectivity. Entities performing these tasks may also be split between the M2M gateway and the M2M network (and/or the access network) for case 4 connectivity.

In both case 3 and 4 connectivity cases, based on the policy that is configured, the M2M gateway may asynchronously register and authenticate with the M2M access network and M2M core network before the M2M devices register with the M2M gateway. The M2M gateway may delay the registration and authentication to the M2M access network and M2M core network until after the devices complete authentication. Prior to accepting registration from the devices and beginning registration with the M2M core/M2M access network, the M2M device may perform its own integrity check and validation process, e.g., autonomously or semi-autonomously.

Case 3 and 4 device integrity validations may include one or more of the flows illustrated in FIG. 8. FIG. 8 illustrates M2M device(s) 802, M2M gateway 804 (which may include a local AAA), network operator 806 (which may include the access network), and M2M operator 808 (which may include the M2M core (GMAE/DAR)). At 820, M2M gateway 804 may perform its own integrity check and validation, either autonomously or semi-autonomously. At 824, M2M device(s) 802 may perform its integrity check and validation and if it succeeds, proceed with gateway acquisition, registration and authentication at 828. The gateway may authenticate the M2M device(s) 802 with the help of a local AAA server. The gateway may start accepting the device registrations and authentication requests: 1) as soon as it completes its own integrity check and validation; or 2) after it registers with the M2M access network and/or M2M core network. At 832, the gateway may register and authenticate with the M2M access network (e.g., network operator 806) and/or the M2M core network (M2M operator 808) asynchronously and agnostically of the M2M device registrations and authentications, or, it may delay its registration and authentication until the M2M device(s) 802 are registered and authenticated at the M2M gateway 804.

At 836, M2M registration and authentication may be performed between M2M gateway 804 and M2M operator 808. If one or more devices connected to M2M gateway 804 fails the device integrity check, then such a list of failed devices or a list of failed functionalities (e.g., in case the devices are sensors) may be sent from the M2M gateway 804 to the M2M core network (M2M operator 808). Depending on the failure (e.g., total failure or failure of particular functionality), the device assessed as having failed the integrity checking may be denied network access, or access may be restricted (e.g., in terms of time, type, or scope). In some cases, such as body area networks, or other wireless sensor area networks, if any one or multiple devices are assessed as having failed the integrity checking, then the M2M gateway 804 may, if such capability exists in the capillary network and the gateway, attempt to co-ordinate a functionality or topology update of the remaining devices, so that the new topology or new functionalities on the remaining devices may compensate for the failure or reduced functionality of the devices who have failed integrity checks. If a network requires high-level assurance for the devices in an M2M area network (e.g., capillary network), the M2M gateway, after detecting integrity breach or failure on one or more devices in the M2M area network, may take measures, by itself or in collaboration with or under supervision from the M2M network domain, to quarantine all devices in the M2M area network or a subset thereof.

For case 4 connectivity, at 840, finer grained integrity verification may be performed between M2M gateway 804 and network operator 806. At 844, finer grained integrity verification may be performed between M2M gateway 804 and M2M device(s) 802. At 848, the results of 844 may be reported to network operator 806.

At 852, device runtime integrity failure may be determined/reported and/or device deregistration may be performed between M2M device(s) 802 and M2M gateway 804. At 856, updated functionality and/or an updated list of devices may be reported between M2M gateway 804 and M2M operator 808.

Case 1 device integrity and registration may include one or more of the flows illustrated in FIG. 9. FIG. 9 illustrates M2M device 902, network operator access network 904, network operator authentication server 906 (may perform as platform validation entity), security capability 908, AAA/GMAE 910 and other capability 912. For case 1 connectivity, the M2M device 902 may be directly connected to the M2M access network, network operator access network 904.

At 920, M2M device 902 may perform integrity checking. At 922, M2M device 902 may acquire network operator access network 904. At 924, access authentication may be established (which may include integrity validation information) between network operator access network 904 and network operator authentication server 906. At 928, access authentication may be established (which may include integrity validation information) between M2M device 902 and network operator access network 904. Using the secure boot process, the M2M device 902 may boot up and perform autonomous validation or the steps involved in semi-autonomous validation. As an alternative to semi-autonomous validation, remote validation procedures may also be performed.

If autonomous validation is used at the M2M device 902, then after the device integrity check and validation, the device may proceed to acquire the M2M access network and attempt to connect and register to the M2M access network.

If semi-autonomous validation is used at the M2M device 902, the device may perform the local device integrity checks, then after the network acquisition, the device may send the results of the local device integrity checks to the M2M network operator and/or M2M access network platform validation entity, whichever is applicable. The platform validation entity may be co-located with the operator's authentication server (M2M operator or access network operator) as illustrated in the flow diagram in FIG. 9, however, the platform validation entity may be a separate entity in the network. The results of the device integrity checks may be the list of the failed components, modules or the functionalities. The platform validation entity may perform the device integrity validation and then proceed with the device authentication.

The identity used by the device may be the trusted platform identifier if the access network or M2M operator network secret keys are not bootstrapped yet. If they are present, then they may also be used in addition or individually.

If the authentication is successful, then the link and network session setup may follow at 930. If M2M access network authentication is successful then this result may be used for single sign-on to the M2M system at 926. Thus the M2M access network identity and authentication results may be used in M2M system identity and authentication. A successful authentication with a M2M access network may imply successful identification and authentication with another M2M access network, with the M2M system or with the M2M core, or, with certain service capabilities or applications provided by the M2M network or other service providers. Bootstrapping and M2M registration may follow. For example, at 932, M2M device 902 may make an M2M bootstrap request to security capability 908. At 934, M2M security bootstrapping may take place between M2M device 902 and security capability 908. At 936, device provisioning (M2M NAI and root key) may take place between security capability 908 and AAA/GMAE 910. At 938, M2M registration, which may include authentication and session keys, may take place between M2M device 902 and security capability 908. At 940, M2M authentication may take place between security capability 908 and AAA/GMAE 910. At 942, security capability 908 may provide encryption keys to other capability 912.

Case 2 device and gateway integrity and registration may include one or more of the flows illustrated in FIG. 10. FIG. 10 illustrates M2M device 1002, M2M gateway 1004, access network 1006 (e.g., associated with the network operator), authentication server 1008 (e.g., associated with the network operator), security capability 1010, AAA/GMAE 1012 and other capability 1014.

At 1020, M2M device 1002 may perform local integrity checking. At 1024, M2M gateway 1004 may perform local integrity checking. At 1028, integrity validation information may be shared between M2M gateway 1004 and access network 1006. At 1032, M2M device 902 may acquire access network 1006. At 1036, access authentication may be established (which may include integrity validation information) between M2M device 1002 and access network 1006. At 1040, access authentication may be established (which may include integrity validation information) between access network 1006 and authentication server 1008. In case 2 connectivity, the M2M device may connect to the M2M system via a M2M gateway. The integrity checks and validation may have to be performed at the M2M device and/or M2M gateway. The M2M gateway may perform either autonomous validation or semi-autonomous validation. This may be executed independent of the autonomous or semi-autonomous validation at the devices.

The gateway may use a secure boot process and perform the local integrity checks and if autonomous validation is used, may perform the validation of the results of the local integrity checks locally. If semi-autonomous validation is used, then the gateway may send the results of the local integrity checks to the platform validation entity in the operator's network. The platform validation entity may be co-located with the AAA server of the operator, e.g., AAA/GMAE 1012. Following a successful integrity check and validation, the gateway may boot up to a ready state in which it may be available to the M2M devices to provide services. The M2M devices may use a secure boot process and perform the local integrity check and if autonomous validation is used then perform the validation of the results of the local integrity checks locally. If semi-autonomous validation is used, then it may acquire the network by searching for the M2M gateway and sending the results to the platform validation entity in the operator's network. The M2M gateway may act as a security gateway and perform access control to provide the M2M devices with access to the network that may be limited to device integrity validation procedures. The platform validation entity may perform the device integrity validation and inform the device and the gateway of the results. If the result is successful, then, at 1048, link and network session setup may be established between the M2M device 1002 and access network 1006 for the procedures of bootstrap, registration and authentication to the access network and the core network. If M2M access network authentication is successful then this result may be used for single sign-on to the M2M system at 1044. The M2M access network identity and authentication results may be used in M2M system identity and authentication. A successful authentication with M2M access network 1006 may imply successful identification and authentication in another M2M area network, with the M2M system or with the M2M core, or with one or more service capabilities or applications provided by the M2M network or other service providers. Bootstrapping and M2M registration may follow. For example, at 1052, M2M device 1002 may make an M2M bootstrap request to security capability 1010. At 1056, M2M security bootstrapping may take place between M2M device 1002 and security capability 1010. At 1060, device provisioning (M2M NAI and root key) may take place between security capability 1010 and AAA/GMAE 1012. At 1064, M2M registration, which may include authentication and session keys, may take place between M2M device 1002 and security capability 1010. At 1068, M2M authentication may take place between security capability 1010 and AAA/GMAE 1012. At 1072, security capability 1010 may provide encryption keys to other capability 1014.

Case 3 device and gateway integrity and registration may include one or more of the flows illustrated in FIG. 11. FIG. 11 illustrates M2M device 1102, M2M gateway 1104, access network 1106 (e.g., associated with the network operator), authentication server 1108 (e.g., associated with the network operator), security capability 1110, AAA/GMAE 1112 and other capability 1114.

At 1120, M2M device 1102 may perform local integrity checking. At 1124, M2M gateway 1104 may perform local integrity checking. At 1128, access authentication, which may include integrity validation information, may take place between M2M gateway 1104 and authentication server 1108. At 1132, capillary registration and authentication, which may include device integrity validation, may take place between M2M device 1102 and M2M gateway 1104.

At 1136, M2M gateway 1104 may acquire access network 1106. At 1140, access authentication may be established (which may include integrity validation information) between M2M gateway 1104 and access network 1106. At 1144, access authentication may be established (which may include integrity validation information) between access network 1106 and authentication server 1108. If M2M access network authentication is successful then this result may be used for single sign-on to the M2M system at 1148.

In the case 3 connectivity, the M2M gateway may act as a M2M device towards the network. As illustrated in FIG. 11, one or more of the following integrity check and registration procedures may be followed.

The gateway may use secure boot process and performs the local integrity checks and if autonomous validation is used, then performs the validation of the results of the local integrity checks locally. If semi-autonomous validation is used, then the gateway may send the results of the local integrity checks to the platform validation entity in the operator's network (access network operator or the M2M network operator). The platform validation entity may be co-located with the AAA server of the operator (access network operator or the M2M network operator). Following a successful integrity check and validation, the gateway may boot up to a ready state, where it may be available to the M2M devices to provide services. Note that in this case, the M2M gateway appears as a M2M device to the network, which is connected with case 1 connectivity. The procedures that are described for case 1 connectivity described above may be followed with the M2M gateway 1104 acting as an M2M device.

After the M2M gateway has completed its integrity check and registration with the M2M access network and M2M service capability, it may then be available to the M2M devices that may want to connect to it. The M2M devices may use secure boot processes, perform the local integrity check and if autonomous validation is used, then perform the validation of the results of the local integrity checks locally. If semiautonomous validation is used, then M2M devices may acquire the network by searching for the M2M gateway and sending the results to the M2M gateway. The M2M gateway may act as a platform validation entity and perform device integrity validation procedures and inform the device of the results. If the result is successful, at 1152, link and network session setup may be established between the M2M gateway 1104 and access network 1106 for the procedures of bootstrap, registration and authentication to the M2M gateway.

The M2M Devices may then the procedures of bootstrap, registration and authentication to the access network and/or the core network. For example, at 1156, M2M gateway 1104 may make an M2M bootstrap request to security capability 1110. At 1160, M2M security bootstrapping may take place between M2M gateway 1104 and security capability 1110. At 1164, device provisioning (M2M NAI and root key) may take place between security capability 1110 and AAA/GMAE 1112. At 1068, M2M registration, which may include authentication and session keys, may take place between M2M gateway 1104 and security capability 1110. At 1172, M2M authentication may take place between security capability 1110 and AAA/GMAE 1112. At 1176, security capability 1110 may provide encryption keys to other capability 1114.

In case 3 connectivity, the M2M devices connected to the M2M gateway may not be visible to the M2M system. Alternatively, the M2M devices or a subset of the M2M devices may be visible to the M2M system as independent M2M devices. In this case, the M2M gateway may perform as a network proxy and perform the authentication and act as a platform integrity validation entity for the devices, or a subset of devices, connected to it.

Case 4 device and gateway integrity and registration may include one or more of the flows illustrated in FIG. 12. FIG. 12 illustrates M2M device 1202, M2M gateway 1204, access network 1206 (e.g., associated with the network operator), authentication server 1208 (e.g., associated with the network operator), security capability 1210, AAA/GMAE 1212 and other capability 1214.

At 1220, M2M device 1202 may perform local integrity checking. At 1224, M2M gateway 1204 may perform local integrity checking. At 1228, access authentication, which may include integrity validation information, may take place between M2M gateway 1204 and authentication server 1208. At 1232, capillary registration and authentication, which may include device integrity validation, may take place between M2M device 1202 and M2M gateway 1204.

At 1236, M2M gateway 1204 may acquire access network 1206. At 1240, access authentication may be established (which may include integrity validation information) between M2M gateway 1204 and access network 1206. At 1244, access authentication may be established (which may include integrity validation information) between access network 1206 and authentication server 1208. If M2M access network authentication is successful then this result may be used for single sign-on to the M2M system at 1248.

In case 4 connectivity, the M2M gateway acts as a proxy for the network towards the device. As illustrated in FIG. 12, one or more of the following integrity check and registration procedures may be followed.

The gateway may use secure boot processes and perform the local integrity checks and if autonomous validation is used, then may perform validation of the results of the local integrity checks locally. If semi-autonomous validation is used, then the gateway may send the results of the local integrity checks to the platform validation entity in the operator's network (e.g., access network operator or the M2M network operator). The platform validation entity may be co-located with the AAA server of the operator (e.g., access network operator or the M2M network operator). Following a successful integrity check and validation, the gateway may boot up to a ready state, where it may be available to the M2M devices to provide services. After the M2M Gateway has completed its integrity check and registration with the M2M access network, it is available to the M2M devices that may want to connect to it.

M2M devices may use secure boot processes and perform the local integrity check and if autonomous validation is used, then may perform the validation of the results of the local integrity checks locally. If semi-autonomous validation is used, then it may acquire the network by searching for the M2M gateway and sending the results to the M2M gateway. The validation of the devices may be performed by the platform validation entities of the M2M gateway and the M2M access network and M2M service layer capability in a split fashion. Exemplary ways to handle validation include: validation may be handled exclusively at the M2M gateway; validation may be handled by the access network; validation may be handled by the M2M service layer capability located in the validation entity; or validation may be performed by the validating entities where the granularity of the validation is performed in a split fashion.

The M2M gateway's platform validation entity may perform a coarse validation followed by the finer validation by the higher up validation entities or vice versa. Fine grained integrity verification may take place between M2M gateway 1204 and authentication server 1208. Fine grained integrity verification using area network protocol message may take place between M2M device 1202 and M2M gateway 1204. Such a mechanism may be used with the tree formed validation where the device integrity check results are collected in a tree form reflecting the device architecture. The tree may be constructed such that the validation of the parent node may indicate the leaf node modules. This concept may be applied recursively until a root node is formed and the verification of the root node metric validates the entire tree and hence the leaf nodes which represent the software modules. The sub trees may be organized according to the software structure. The M2M gateway validating entity may perform a coarse granularity check by checking the roots of a set of subtrees. This information may be fed to the validating entity of the access or the M2M operator's validating entity. The validating entity in the network may assess the results and based on the assessment, decide to perform a finer grained validation. It may then instruct the validation entity in the M2M gateway to obtain results of the finer grained integrity tests. Report results may be exchanged between M2M gateway 1204 and authentication server 1208. Thus the M2M gateway may act as a platform validation entity in a layered fashion and appear as a proxy for the network and perform device integrity validation procedures and inform the device of the results. If the result is successful, then, at 1252, the device may begin the process of link and network session setup between M2M gateway 1204 and access network 1206 for the procedures of bootstrap, registration and authentication to the M2M gateway 1204. Alternatively, the device may start the procedures of bootstrap, registration and authentication to the access network and the core network. The M2M devices connected to the M2M gateway may not be visible to the M2M system. Alternatively, M2M devices, or a subset of M2M devices, may be visible to the M2M system as independent M2M devices. In such a case the M2M gateway performs as a network proxy and performs the authentication and acts as a platform integrity validation entity for the devices, or a subset of devices, connected to it.

The M2M network may validate the integrity of a large group of devices, e.g., a whole network-worth of devices and their gateway using a layered validation method, which may be facilitated by a M2M gateway.

The M2M gateway may first collect from devices (e.g., all devices, groups of devices, a subset of devices, etc.) that are connected to it, integrity-evidence (such as hash) of the individual devices. The integrity evidence may be in the form of a tree-structure, where the root of the individual tree represents the highest-level digest of the device integrity of an individual device, while its branches may represent functionalities or capabilities of the individual device, and the leaves of the tree may represent individual files/components such as, but not limited to, SW binary files, configuration files, or individual indicators of hardware component integrity.

By initiation of the M2M gateway or by initiation of the M2M server (which may be a validation server, a platform validation entity (PVE) in the Home eNode-B or platform validation authority (PVA) in the M2M), the M2M gateway may send to the M2M server aggregated information on the device integrity of 1) its own, gateway functionality, and 2) high-level summarized information about the integrity of the M2M devices (e.g., all devices, groups of devices, a subset of devices, etc.) connected to the M2M gateway.

After receiving and assessing the information from the M2M gateway, the M2M server may ask for more detailed information about the integrity of the M2M gateway or M2M devices whose integrity has been reported previously (e.g., all devices, groups of devices, a subset of devices, etc.). After receiving this request, the M2M gateway may, for example, 1) send, to the M2M server, the more detailed information about the integrity of either itself or the M2M devices that it has already previously collected and has in its store, or, 2) collect such more detailed information and then send it to the M2M server. Such “more detailed information” may be found from a tree or tree-like structured data, where the root of the tree may show a very high-level summary of the integrity of the whole sub-network comprising of the M2M gateway and the M2M devices connected to it (e.g., all devices, groups of devices, a subset of devices, etc.), and the lower nodes and leaves may indicate lower-level, more detailed information, about a device, e.g., its functionalities. FIG. 13 depicts an exemplary scenario for layered validation. The large triangle 1310 may depict a tree or tree-like structure where the top apex of the triangle represents a very high-level summary version of the integrity data that represents the overall health of the entire sub-network coordinated by the M2M gateway 1300. The larger tree may include, as part of it, one or more smaller triangular shapes 1315, each of which may represent integrity information about one or more of the devices 1330 that comprise the sub-net coordinated by the M2M gateway 1300.

Further, the M2M gateway 1300 may group connected devices based on type, class, or other descriptors and possibly provide group certificates for their integrity trees. This is depicted in FIG. 13 with the smaller triangles that have certificates in them 1317. Use of such trusted certificates may facilitate the Multi-Network Operator (MNO) network 1320 to have more trust in the reported integrity values.

The scenario described above may also be applied to, or include, a peer-to-peer (P2P) approach, where M2M devices exchange and certify tree or tree-like integrity-proving data structures amongst each other or in clusters with verifier nodes, where there may be dedicated verifier nodes, or, in ad-hoc nodes, where any node may take a role of a verifier node.

The service capability (SC) in the service capabilities of the network and application domain may provide one or more of: key management, authentication and session key management, or device integrity verification.

Key management may include how to manage security keys by means of bootstrap of security keys (for example pre-shared security keys, certificates, etc.) in the device for authentication.

Authentication and session key management may be configured to perform one or more of the following: service layer registration through authentication; service session key management between the M2M device/M2M gateway and the SC; authenticate applications before providing service; communicate negotiated session keys to the messaging capability so as to perform (by the messaging capability) encryption/integrity protection on data exchanged with the M2M devices and M2M gateways; or, set up security tunnel sessions from M2M gateways and devices if applications require tunnel security (e.g., tunnel between home gateway and the service capability entity for messaging). Device integrity verification may be configured to validate the integrity of device or gateway.

The SC in the M2M device or the M2M gateway may be configured to perform one or more of the following: manage security keys by means of bootstrap of security keys (e.g., pre-shared security keys, or certificates) in the device for authentication; perform authentication before session establishment if required by the application; session security related functions such as encryption of traffic and integrity protection for signaling messages; (for devices/gateways that are capable) perform measurement, verification and/or reporting of the integrity of the device (or gateway); support procedures of secure time synchronization; negotiate and use applicable security specific service class properties; support fault-recovery mechanisms; or, support access control of M2M devices to the M2M core.

Although features and elements may be described above in particular combinations, each feature or element may be used alone without the other features and elements or in various combinations with or without other features and elements. The methods or flows provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

Disclosed hereinafter are systems, methods, and instrumentalities that may be implemented in conjunction with, or as part of, the above disclosed matter.

FIG. 14 illustrates an exemplary M2M architecture. The diagram includes the M2M service capabilities 1430 on a machine-to-machine (M2M) network and the M2M device/gateway entities. FIG. 14 includes M2M device/M2M gateway 1410, capability level interfaces 1460, M2M service capabilities 1430, M2M application 1420, resource interfaces 1490, core network A 1440, and core network B 1450. M2M device/M2M gateway 1410 may comprise M2M application 1412, M2M capabilities 1414, and communication modules 1416. M2M service capabilities 1430 may include capabilities C1, C2, C3, C4 AND C5, as well as generic M2M application enablement capability 1470.

FIG. 15 illustrates an exemplary internal functional architecture of the M2M service capabilities of the M2M network layer. As illustrated, FIG. 15 may comprise components of FIG. 14. In FIG. 15, the M2M network service layer may comprise one or more capabilities including: generic message delivery (GM); reachability 60, addressing and device application repository (RADAR) 30; network and communication service selection (NCSS) 20; M2M device and M2M gateway management (MDGM) 10; historization and data retention (HDR) 70; generic M2M application enablement (GMAE) 1470; security capability (SC) 50; or transaction management (TM) 40.

In a case A connectivity, the M2M device may be directly connected to the M2M access network, from a service-capability point of view. In this sense, the connectivity cases 1 and 2 described herein may be considered examples of connectivity case A. If there is a M2M gateway that, while connecting to peripheral devices which the M2M network is not aware of via a capillary network, also connects to the M2M Access network, then such a M2M gateway may be considered a M2M device that connects directly to the M2M access network, e.g., achieving case 1 connectivity.

In a case B connectivity, the M2M gateway may act as a network proxy, performing the procedures of authentication, authorization, registration, device management, and provisioning of the M2M devices connected to it, and also executes applications, on behalf of the M2M network and application domain. In case B connectivity, the M2M gateway may decide on routing service layer requests originating from applications on M2M devices locally or to the M2M network and application domain. The herein-described connectivity cases 3 and 4 may be examples of connectivity case B.

A new architecture and specific functionalities for the service capabilities for the M2M gateway are described in greater detail hereafter.

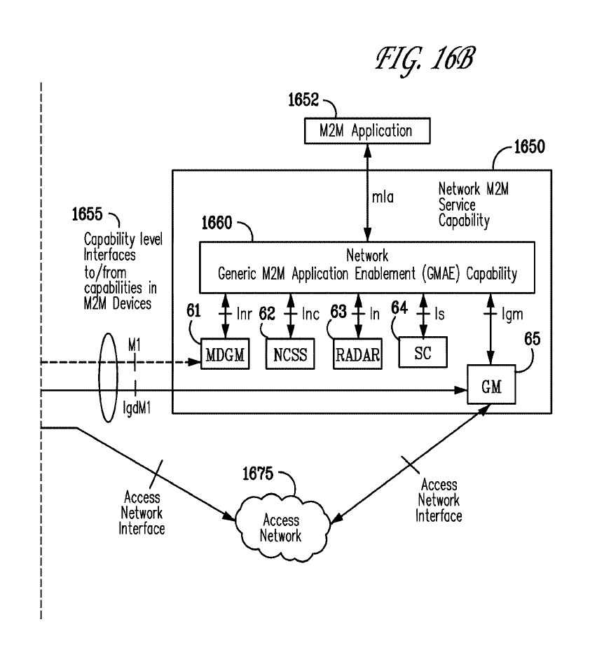

FIGS. 16A and 16B show an exemplary functional architecture of the M2M gateway and its interfaces. FIGS. 16A and 16B includes gateway M2M service capability 1610, network M2M service capability 1650, M2M application 1612, M2M application 1652, capability level interfaces 1615, capability level interfaces 1655, M2M device 1630, capillary network 1635, and capillary network 1675, as well as additional components described herein. The service capabilities considered may include gGMAE 1620, gGM 26, gMDGM 21, gNCSS 22, gRADAR 23, and gSC 24. Each of these capabilities may be the capabilities of the M2M gateway that correspond and act as proxies to the capabilities GMAE 1650, GM 65, MDGM 61, NCSS 62, RADAR 63, and SC 64 of the M2M core, respectively.

The high-level functionalities for each of these M2M gateway capabilities applicable to a M2M gateway that acts as a M2M network's proxy are described in greater detail hereafter.

The gGMAE 1620 is a capability of a M2M gateway that acts as a proxy of the GMAE 1660 of the network and application domain (NAD), and may provide 1) applications for the M2M devices that connect to the network-proxy M2M gateway, as well as 2) applications for the M2M gateway itself.

The gGM 26 is a M2M gateway capability that acts as a proxy of the GM 65 of the NAD, and may provide the ability to transport messages between one or more of the following objects: M2M device, network-proxy M2M gateway, proxy service capabilities residing in the network-proxy M2M gateway, and M2M applications enabled by the gGMAE 1620, and service capabilities of the NAD, and M2M applications residing in the NAD.

The gMDGM 21 is a M2M gateway capability that acts as a proxy of the MDGM 61 of the NAD, and may provide management functions, such as configuration management (CM), performance management (PM), and fault management (FM), for both the M2M devices that are connected to it, as well as all of the capabilities and interfaces of the M2M gateway itself.

The gNCSS 22 is a M2M gateway capability that acts as a proxy of the NCSS 62 of the NAD, and may provide communication and network service selection capabilities for the M2M devices connected to it, as well as to the M2M gateway itself.

The gRADAR 23 is a M2M gateway capability that acts as a proxy of the RADAR 63 of the NAD. Its functionalities comprise the below descriptions.

The gSC 24 is a M2M gateway capability that acts as a proxy of the SC 64 of the NAD.

In addition to these capabilities that have counterparts in the NAD, a M2M gateway capability called for gMMC 25 may be included that performs functions for managing M2M device mobility across M2M gateways in the service and applications domain. This capability gMMC 25 is not shown in FIG. 15 above, but may be considered as residing in the network-proxy gateway nonetheless.

The gateway service capabilities may comprise multiple (e.g., three) sub-capabilities, denoted by “_DG”, “_G”, and “_GN” as illustrated in FIG. 16A. For the functionality “gX”, “gX_DG” may denote the sub-capability responsible fox interacting with the M2M device that are connected to the gateway, “gX_G” may denote the sub-capability responsible for an autonomous functionality of the gateway that is part of the capability of “gX”, and “gX_GN” may denote the sub-capability responsible for interacting with the M2M service core.

In addition to these capabilities, and as illustrated in FIGS. 16A and 16B, the architecture of the network-proxy M2M gateway may comprise a number of interfaces between the capabilities described above, as well as the interfaces from the network-proxy M2M gateway toward either the M2M devices or the M2M network and its various capabilities. Exemplary interface names are illustrated in FIGS. 16A and 16B.

One or more of the following may apply to the gateway generic M2M application enablement (gGMAE) capability.

The M2M applications may reside in the M2M device, M2M gateway or the M2M network and applications domain.

Functionalities of a gGMAE, such as gGMAE 1620 may include one or more of the following for the network-based GMAE 1660.

The gGMAE may expose functionalities implemented in the service capabilities of the M2M core and the network-proxy service capabilities of the M2M gateway via a single interface, such as gIa in FIG. 16A. It may hide the gateway service capabilities topology, so that information needed by an M2M application in order to use the different network-proxy service capabilities of the M2M gateway may be limited to the address of the gGMAE capability. It may allow an M2M application to register to the gateway service capabilities.

The gGMAE may also be configured to perform authentication and authorization of M2M applications before allowing them to access a specific set of capabilities. The set of capabilities an M2M application is entitled to access may assume a prior agreement between the M2M application Provider and the Provider running the service capabilities. In the case the M2M application and the service capabilities are run by the same entity, the authentication requirement may be relaxed. It may also check if a specific request on Interface gla is valid before routing it to other Capabilities. If a request is not valid an error may be reported to the M2M application,

The gGMAE may further be configured to perform routing between M2M applications and capabilities in the proxy service capabilities. Routing may be defined as the mechanism by which a specific request is sent to a particular capability or an instance of that capability when e.g., load balancing is implemented. It may perform routing between different proxy service capabilities. And, it may generate charging records pertaining to the use of service capabilities.

Additionally, gGMAE capability in the M2M gateway may be configured to perform reporting, to the GMAE capability in the M2M NAD, of the status and/or results of Registration, Authentication, and Authorization of the M2M devices. Such reporting may be performed by one or more of the following:

By its own initiation, e.g., periodically using a timer provided either locally in the device and/or external timing synchronization.

In response to commands from the GMAE capability of the M2M network (i.e., on-demand).

By its own initiation of a request to, and a subsequent receipt of a response from, the GMAE of the NAD.

One or more of the following may apply to the reachability, addressing and device application repository capability.

The RADAR capability in the M2M gateway, such as gRADAR 23, may be configured to provide a capability to reveal or hide the underlying capillary network topology, addressing and routing from the service capabilities in the M2M network and applications domain, according to policies and/or commands of the M2M network and applications domain. It may also support M2M device mobility across M2M gateways by relaying M2M applications and service layer messages and data.

The RADAR capability in the M2M gateway, such as gRADAR 23, may further be configured to provide functionality that maintains the gateway device application Repository (gDAR) by storing in the device application repository the M2M device application registration information of M2M devices and keeping this information up to date. Additionally, it may provide the functionality by providing a query interface to authenticate and authorize entities residing in the network and application domain for them to be able to retrieve M2M device applications registration information. Additionally, it may provide the functionality by providing, upon request, this information to entities residing in the network and application domains, e.g., assuming the requesting entity is authenticated and authorized to perform such a query.

The gRADAR 23 and RADAR 63 (of the NAD) may both be configured to provide one or more of the following: 1) a cloud-like, network-based application execution, 2) a downloadable, application-store-like application repository, or 3) registering and authorizing/activating the use of provisioned applications on the device, in a way similar to DRM Rights Issuing.

One or more of the following may apply to the network and communication service selection (NCSS) capability.

The NCSS capability, such as NCSS 62, may include one or more of the following functionalities.

The NCSS capability may be configured to hide the use of the network addresses from the M2M application. It may provide network selection when the M2M device or M2M gateway can be reached through several networks via several subscriptions. Additionally it may provide the communication service selection when a M2M device or M2M gateway has several network addresses.

Additionally, the NCSS capability may be configured to take into account the requested service class for the purpose of network and communication service selection. And it may provide alternative network or communication service selection after a communication failure, e.g., using a first selected network or communication service.

The NCSS capability in the M2M gateway, such as gNCSS 22, may be configured to hide the use of the access network from the M2M application and service layer. It may provide access network selection when multiple access networks are available.

The gNCSS may further be configured to take into account the requested service class for the purpose of network and communication service selection. And, it may provide alternative network or communication service selection after communication failure, e.g., using a first selected network or communication service.

One or more of the following may apply to the security capability (SC).

The SC in the service capabilities of the network and application domain, such as SC 64, may be configured to provide one or more of the following: Key management, Authentication and Session Key management, or device integrity validation.

Key management may include managing security keys using a bootstrap of security keys (for example pre-shared security keys, certificates, etc.) in the device for authentication. It may also include obtaining provisioning information from application and inform the operator network as needed.

Authentication and Session Key management may include performing service layer registration through authentication. It may also include performing service session key management between the M2M device/M2M gateway and the SC. It may also include authenticating applications before providing service.

Authentication and Session Key management may further include interfacing with an AAA server to obtain authentication data needed to perform M2M device application or M2M gateway application authentication and session key management. The SC may serve as the “authenticator” in AAA terminology. It may also communicate negotiated session keys to the Messaging capability so as to perform (by the messaging capability) encryption/integrity protection on data exchanged with the M2M devices and M2M gateways.

Authentication and Session Key management may further include setting up security tunnel sessions from M2M gateways and devices if applications require tunnel security (e.g. tunnel between home gateway and the service capability entity: messaging).

Device integrity validation may involve the M2M network validating the integrity of device or gateway for M2M devices and gateways that support device integrity validation. Additionally, the M2M network may trigger post-validation actions such as access control.

The SC in the M2M device or the M2M gateway may be configured to manage security keys by bootstraping of security keys (for example pre-shared security keys, certificates, etc.) in the device for authentication. It may also obtain provisioning information from application and inform the operator network as needed. It may further be configured to perform authentication before session establishment e.g., if required by the application

The SC in the M2M device or the M2M gateway may be configured to perform session security related functions such as encryption of traffic and integrity protection for signalling messages. Also, (for devices/gateways that are capable) it may perform verification and/or reporting of the integrity of the device or gateway. Additionally, it may, (for devices/gateways that are capable), support procedures of secure time synchronization

The SC in the M2M device or the M2M gateway may further be configured to negotiate and use applicable security specific service class properties. And, subject to M2M operator's policy, it may block access of any M2M device to the network and applications domain if the M2M device that is capable of performing integrity verification fails in this procedure.

The NAD-based SC may be configured, in addition to the functionalities described above, to initiate MDGM capability to update firmware or software of the M2M device.

Additionally, for the gateway security capability (gSC) of a network-proxy M2M gateway, the SC may be configured to manage security keys for use by M2M device or M2M applications.

The SC may perform service-level authentication of M2M devices (as a proxy for the authentication functionality of the SC in the NAD) and as a result support for service layer and application registration.

The SC may report the results of such authentication to the security capability in the NAD on an individual M2M device or group basis. The SC may perform service-level authentication of itself, toward the SC in the NAD.

The SC may setup and interwork a security tunnel session from the M2M gateway (toward either the M2M device(s) or the M2M core) if applications require such tunnelled security. Additionally, the SC may perform procedures to verify and validate the integrity of the M2M devices, on behalf of the SC of the NAD.

The SC may further be configured to report the results of such verification and validation to the security capability in the NAD on an individual M2M device or group basis. Additionally, the SC may perform procedures to attest to its own integrity to the security capability in the NAD. Additionally, the SC may trigger post-validation actions for the M2M devices, such as access control and remediation including initiation of the gMDGM capability or the MDGM (in the NAD) to update firmware or software of the M2M device.

The SC may further be configured to perform one or more of the following functionalities 1) as a response to a command originating from a capability of the M2M NAD, 2) as a response to a command that it receives from the M2M NAD subsequent to a request for such execution autonomously generated from the M2M gateway, or 3) autonomously initiated execution of the functionalities whereby the gSC then subsequently reports about the procedure or the result(s) of such execution to the capabiliti(es) of the M2M NAD.

Although features and elements are described above in particular combinations, each feature or element can be used alone without the other features and elements or in various combinations with or without other features and elements. The methods or flows provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

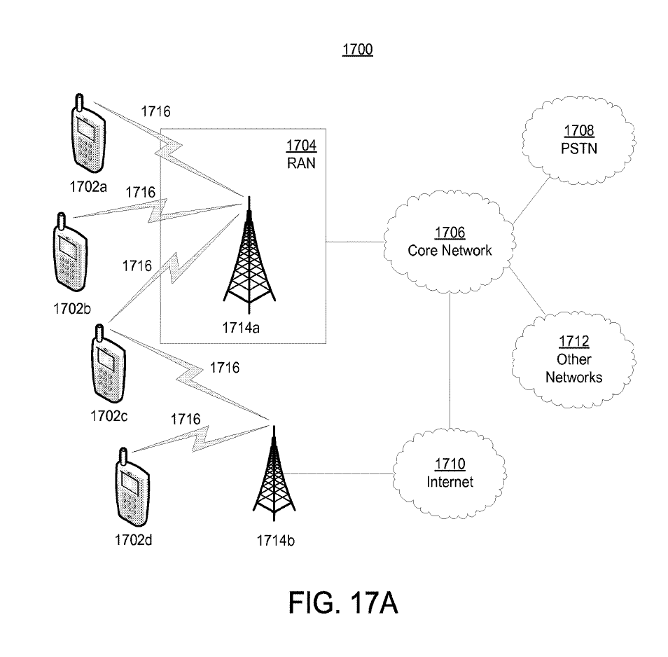

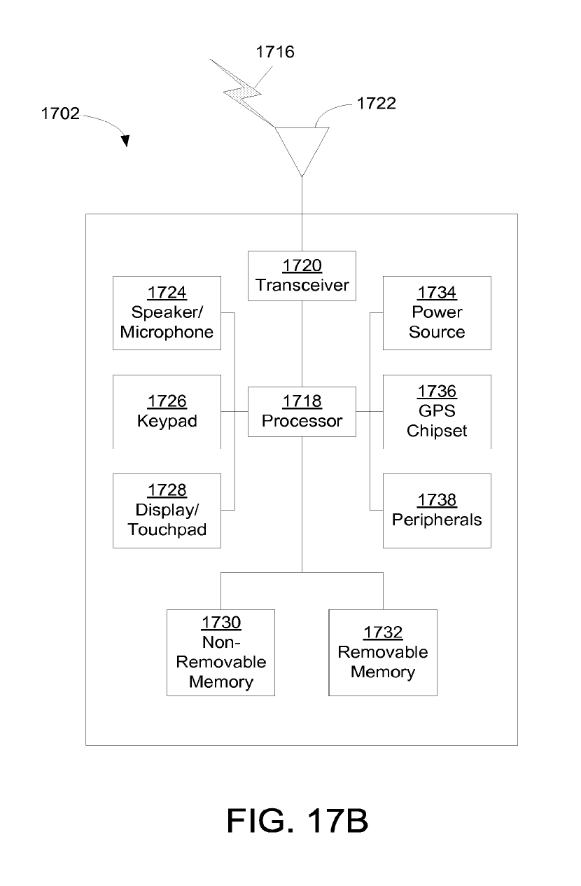

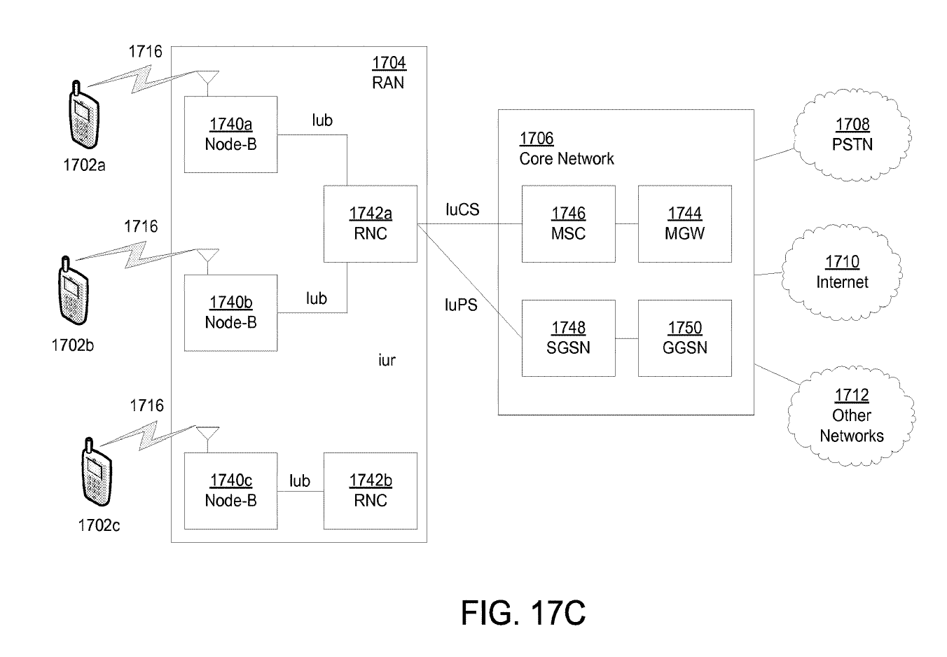

FIG. 17A is a diagram of an example communications system 1700 in which one or more disclosed embodiments may be implemented. The communications system 1700 may be a multiple access system that provides content, such as voice, data, video, messaging, broadcast, etc., to multiple wireless users. The communications system 1700 may enable multiple wireless users to access such content through the sharing of system resources, including wireless bandwidth. For example, the communications systems 1700 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 17A, the communications system 1700 may include wireless transmit/receive units (WTRUs) 1702a, 1702b, 1702c, 1702d, a radio access network (RAN) 1704, a core network 1706, a public switched telephone network (PSTN) 1708, the Internet 1710, and other networks 1712, though it will be appreciated that the disclosed embodiments contemplate any number of WTRUs, base stations, networks, and/or network elements. Each of the WTRUs 1702a, 1702b, 1702c, 1702d may be any type of device configured to operate and/or communicate in a wireless environment. By way of example, the WTRUs 1702a, 1702b, 1702c, 1702d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 1700 may also include a base station 1714a and a base station 1714b. Each of the base stations 1714a, 1714b may be any type of device configured to wirelessly interface with at least one of the WTRUs 1702a, 1702b, 1702c, 1702d to facilitate access to one or more communication networks, such as the core network 1706, the Internet 1710, and/or the networks 1712. By way of example, the base stations 1714a, 1714b may be a base transceiver station (BTS), a Node-B, an eNode B, a Home Node B, a Home eNode B, a site controller, an access point (AP), a wireless router, and the like. While the base stations 1714a, 1714b are each depicted as a single element, it will be appreciated that the base stations 1714a, 1714b may include any number of interconnected base stations and/or network elements.

The base station 1714a may be part of the RAN 1704, which may also include other base stations and/or network elements (not shown), such as a base station controller (BSC), a radio network controller (RNC), relay nodes, etc. The base station 1714a and/or the base station 1714b may be configured to transmit and/or receive wireless signals within a particular geographic region, which may be referred to as a cell (not shown). The cell may further be divided into cell sectors. For example, the cell associated with the base station 1714a may be divided into three sectors. Thus, in one embodiment, the base station 1714a may include three transceivers, i.e., one for each sector of the cell. In another embodiment, the base station 1714a may employ multiple-input multiple output (MIMO) technology and, therefore, may utilize multiple transceivers for each sector of the cell.

The base stations 1714a, 1714b may communicate with one or more of the WTRUs 1702a, 1702b, 1702c, 1702d over an air interface 1716, which may be any suitable wireless communication link (e.g., radio frequency (RF), microwave, infrared (IR), ultraviolet (UV), visible light, etc.). The air interface 1716 may be established using any suitable radio access technology (RAT).

More specifically, as noted above, the communications system 1700 may be a multiple access system and may employ one or more channel access schemes, such as CDMA, TDMA, FDMA, OFDMA, SC-FDMA, and the like. For example, the base station 1714a in the RAN 1704 and the WTRUs 1702a, 1702b, 1702c may implement a radio technology such as Universal Mobile Telecommunications System (UMTS) Terrestrial Radio Access (UTRA), which may establish the air interface 1716 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 1714a and the WTRUs 1702a, 1702b, 1702c may implement a radio technology such as Evolved UMTS Terrestrial Radio Access (E-UTRA), which may establish the air interface 1716 using Long Term Evolution (LTE) and/or LTE-Advanced (LTE-A).

In other embodiments, the base station 1714a and the WTRUs 1702a, 1702b, 1702c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 1714b in FIG. 17A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 1714b and the WTRUs 1702c, 1702d may implement a radio technology such as IEEE 802.11 to establish a wireless local area network (WLAN). In another embodiment, the base station 1714b and the WTRUs 1702c, 1702d may implement a radio technology such as IEEE 802.15 to establish a wireless personal area network (WPAN). In yet another embodiment, the base station 1714b and the WTRUs 1702c, 1702d may utilize a cellular-based RAT (e.g., WCDMA, CDMA2000, GSM, LTE, LTE-A, etc.) to establish a picocell or femtocell. As shown in FIG. 17A, the base station 1714b may have a direct connection to the Internet 1710. Thus, the base station 1714b may not be required to access the Internet 1710 via the core network 1706.

The RAN 1704 may be in communication with the core network 1706, which may be any type of network configured to provide voice, data, applications, and/or voice over internet protocol (VoIP) services to one or more of the WTRUs 1702a, 1702b, 1702c, 1702d. For example, the core network 1706 may provide call control, billing services, mobile location-based services, pre-paid calling, Internet connectivity, video distribution, etc., and/or perform high-level security functions, such as user authentication. Although not shown in FIG. 17A, it will be appreciated that the RAN 1704 and/or the core network 1706 may be in direct or indirect communication with other RANs that employ the same RAT as the RAN 1704 or a different RAT. For example, in addition to being connected to the RAN 1704, which may be utilizing an E-UTRA radio technology, the core network 1706 may also be in communication with another RAN (not shown) employing a GSM radio technology.

The core network 1706 may also serve as a gateway for the WTRUs 1702a, 1702b, 1702c, 1702d to access the PSTN 1708, the Internet 1710, and/or other networks 1712. The PSTN 1708 may include circuit-switched telephone networks that provide plain old telephone service (POTS). The Internet 1710 may include a global system of interconnected computer networks and devices that use common communication protocols, such as the transmission control protocol (TCP), user datagram protocol (UDP) and the internet protocol (IP) in the TCP/IP internet protocol suite. The networks 1712 may include wired or wireless communications networks owned and/or operated by other service providers. For example, the networks 1712 may include another core network connected to one or more RANs, which may employ the same RAT as the RAN 1704 or a different RAT.

Some or all of the WTRUs 1702a, 1702b, 1702c, 1702d in the communications system 1700 may include multi-mode capabilities, i.e., the WTRUs 1702a, 1702b, 1702c, 1702d may include multiple transceivers for communicating with different wireless networks over different wireless links. For example, the WTRU 1702c shown in FIG. 17A may be configured to communicate with the base station 1714a, which may employ a cellular-based radio technology, and with the base station 1714b, which may employ an IEEE 802 radio technology.

FIG. 17B is a system diagram of an example WTRU 1702. As shown in FIG. 17B, the WTRU 1702 may include a processor 1718, a transceiver 1720, a transmit/receive element 1722, a speaker/microphone 1724, a keypad 1726, a display/touchpad 1728, non-removable memory 1706, removable memory 1732, a power source 1734, a global positioning system (GPS) chipset 1736, and other peripherals 1738. It will be appreciated that the WTRU 1702 may include any sub-combination of the foregoing elements while remaining consistent with an embodiment.

The processor 1718 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 1718 may perform signal coding, data processing, power control, input/output processing, and/or any other functionality that enables the WTRU 1702 to operate in a wireless environment. The processor 1718 may be coupled to the transceiver 1720, which may be coupled to the transmit/receive element 1722. While FIG. 17B depicts the processor 1718 and the transceiver 1720 as separate components, it will be appreciated that the processor 1718 and the transceiver 1720 may be integrated together in an electronic package or chip.

The transmit/receive element 1722 may be configured to transmit signals to, or receive signals from, a base station (e.g., the base station 1714a) over the air interface 1716. For example, in one embodiment, the transmit/receive element 1722 may be an antenna configured to transmit and/or receive RF signals. In another embodiment, the transmit/receive element 1722 may be an emitter/detector configured to transmit and/or receive IR, UV, or visible light signals, for example. In yet another embodiment, the transmit/receive element 1722 may be configured to transmit and receive both RF and light signals. It will be appreciated that the transmit/receive element 1722 may be configured to transmit and/or receive any combination of wireless signals.

In addition, although the transmit/receive element 1722 is depicted in FIG. 17B as a single element, the WTRU 1702 may include any number of transmit/receive elements 1722. More specifically, the WTRU 1702 may employ MIMO technology. Thus, in one embodiment, the WTRU 1702 may include two or more transmit/receive elements 1722 (e.g., multiple antennas) for transmitting and receiving wireless signals over the air interface 1716.

The transceiver 1720 may be configured to modulate the signals that are to be transmitted by the transmit/receive element 1722 and to demodulate the signals that are received by the transmit/receive element 1722. As noted above, the WTRU 1702 may have multi-mode capabilities. Thus, the transceiver 1720 may include multiple transceivers for enabling the WTRU 1702 to communicate via multiple RATs, such as UTRA and IEEE 802.11, for example.

The processor 1718 of the WTRU 1702 may be coupled to, and may receive user input data from, the speaker/microphone 1724, the keypad 1726, and/or the display/touchpad 1728 (e.g., a liquid crystal display (LCD) display unit or organic light-emitting diode (OLED) display unit). The processor 1718 may also output user data to the speaker/microphone 1724, the keypad 1726, and/or the display/touchpad 1728. In addition, the processor 1718 may access information from, and store data in, any type of suitable memory, such as the non-removable memory 1706 and/or the removable memory 1732. The non-removable memory 1706 may include random-access memory (RAM), read-only memory (ROM), a hard disk, or any other type of memory storage device. The removable memory 1732 may include a subscriber identity module (SIM) card, a memory stick, a secure digital (SD) memory card, and the like. In other embodiments, the processor 1718 may access information from, and store data in, memory that is not physically located on the WTRU 1702, such as on a server or a home computer (not shown).

The processor 1718 may receive power from the power source 1734, and may be configured to distribute and/or control the power to the other components in the WTRU 1702. The power source 1734 may be any suitable device for powering the WTRU 1702. For example, the power source 1734 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 1718 may also be coupled to the GPS chipset 1736, which may be configured to provide location information (e.g., longitude and latitude) regarding the current location of the WTRU 1702. In addition to, or in lieu of, the information from the GPS chipset 1736, the WTRU 1702 may receive location information over the air interface 1716 from a base station (e.g., base stations 1714a, 1714b) and/or determine its location based on the timing of the signals being received from two or more nearby base stations. It will be appreciated that the WTRU 1702 may acquire location information by way of any suitable location-determination method while remaining consistent with an embodiment.

The processor 1718 may further be coupled to other peripherals 1738, which may include one or more software and/or hardware modules that provide additional features, functionality and/or wired or wireless connectivity. For example, the peripherals 1738 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 17C is a system diagram of the RAN 1704 and the core network 1706 according to an embodiment. As noted above, the RAN 1704 may employ a UTRA radio technology to communicate with the WTRUs 1702a, 1702b, 1702c over the air interface 1716. The RAN 1704 may also be in communication with the core network 1706. As shown in FIG. 17C, the RAN 1704 may include Node-Bs 1740a, 1740b, 1740c, which may each include one or more transceivers for communicating with the WTRUs 1702a, 1702b, 1702c over the air interface 1716. The Node-Bs 1740a, 1740b, 1740c may each be associated with a particular cell (not shown) within the RAN 1704. The RAN 1704 may also include RNCs 1742a, 1742b. It will be appreciated that the RAN 1704 may include any number of Node-Bs and RNCs while remaining consistent with an embodiment.

As shown in FIG. 17C, the Node-Bs 1740a, 1740b may be in communication with the RNC 1742a. Additionally, the Node-B 1740c may be in communication with the RNC1742b. The Node-Bs 1740a, 1740b, 1740c may communicate with the respective RNCs 1742a, 1742b via an Iub interface. The RNCs 1742a, 1742b may be in communication with one another via an Iur interface. Each of the RNCs 1742a, 1742b may be configured to control the respective Node-Bs 1740a, 1740b, 1740c to which it is connected. In addition, each of the RNCs 1742a, 1742b may be configured to carry out or support other functionality, such as outer loop power control, load control, admission control, packet scheduling, handover control, macrodiversity, security functions, data encryption, and the like.

The core network 1706 shown in FIG. 17C may include a media gateway (MGW) 1744, a mobile switching center (MSC) 1746, a serving GPRS support node (SGSN) 1748, and/or a gateway GPRS support node (GGSN) 1750. While each of the foregoing elements are depicted as part of the core network 1706, it will be appreciated that any one of these elements may be owned and/or operated by an entity other than the core network operator.

The RNC 1742a in the RAN 1704 may be connected to the MSC 1746 in the core network 1706 via an IuCS interface. The MSC 1746 may be connected to the MGW 1744. The MSC 1746 and the MGW 1744 may provide the WTRUs 1702a, 1702b, 1702c with access to circuit-switched networks, such as the PSTN 1708, to facilitate communications between the WTRUs 1702a, 1702b, 1702c and traditional land-line communications devices.

The RNC 1742a in the RAN 1704 may also be connected to the SGSN 1748 in the core network 1706 via an IuPS interface. The SGSN 1748 may be connected to the GGSN 1750. The SGSN 1748 and the GGSN 1750 may provide the WTRUs 1702a, 1702b, 1702c with access to packet-switched networks, such as the Internet 1710, to facilitate communications between and the WTRUs 1702a, 1702b, 1702c and IP-enabled devices.

As noted above, the core network 1706 may also be connected to the networks 1712, which may include other wired or wireless networks that are owned and/or operated by other service providers.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. In a system comprising a network domain that is capable of providing one or more service capabilities to a plurality of devices in communication with the network domain, a method of offloading certain functionality of the network domain to an entity outside of the network domain, the method comprising, by the entity:
establishing trust with the network domain;
establishing a connection with each of the plurality of devices;
performing a security function for each of the plurality of devices; and
reporting information to the network domain relating to each of the plurality of devices.

2. The method of claim 1, wherein the information is aggregated from each of the plurality of devices.

3. The method of claim 1, wherein aggregated security functions are parsed and performed for each of the plurality of devices.

4. The method of claim 1, wherein the reporting is in response to a request from the network domain.

5. The method of claim 4, wherein the network domain is unaware of an identity of each of the plurality of devices.

6. The method of claim 1, wherein the reporting is performed periodically.

7. The method of claim 1, wherein the security function comprises registering and authenticating each of the plurality of devices with the network domain.

8. The method of claim 7, wherein the registering and authenticating includes using a bootstrapped credential.

9. The method of claim 1, wherein the security function comprises provisioning and migration of credentials to each of the plurality of devices.

10. The method of claim 1, wherein the security function comprises provisioning of security policies to each of the plurality of devices.

11. The method of claim 1, wherein the security function comprises establishing a trustworthy functionality in each of the plurality of devices, wherein an integrity validation for each of the plurality of devices is performed.

12. The method of claim 1, wherein the security function comprises providing device management for each of the plurality of devices.

13. The method of claim 12, wherein a critical failure alarm associated with at least one of the plurality of devices is sent to the network domain.

14. The method of claim 1, wherein the security function comprises establishing, for at least one of the plurality of devices, at least one of: a security association, a communication channel, or a communication link.

15. The method of claim 1, further comprising:
determining an integrity breach or failure associated with one or more of the plurality of devices; and
quarantining the one or more of the plurality of devices.

16. The method of claim 1, wherein the security function is performed on behalf of the network domain without network domain participation.

17. In a system comprising a network domain that is capable of providing one or more service capabilities to a plurality of devices in communication with the network domain, a method of offloading certain functionality of the network domain to an entity outside of the network domain, the method comprising, by the entity:
establishing trust with the network domain;
receiving a command from the network domain to perform a security function relating to each of the plurality of devices;
performing the security function for each of the plurality of devices;
aggregating information from each of the plurality of devices relating to the performed security function; and
sending the aggregated information to the network domain.

18. The method of claim 17, wherein the security function comprises registering and authenticating each of the plurality of devices with the network domain.

19. The method of claim 18, wherein the registering and authenticating includes using a bootstrapped credential.

20. The method of claim 17, wherein the security function comprises provisioning and migration of credentials to each of the plurality of devices.

21.-26. (canceled)
